(19) United States
(12) Patent Application Publication
(10) Pub. No.: US 2010/0223101 A1
(43) Pub. Date: Sep. 2, 2010

(54) SUSTAINABILITY CAPITAL PLANNING TOOL

(76) Inventors: Wiley C. Montague, Novi, MI (US); Timothy R. Walden, Adrian, MI (US)

Correspondence Address: CHRISTOPHER P. MAIORANA, P.C., 24840 HARPER SUITE 100, ST. CLAIR SHORES, MI, 48080, US

(21) Appl. No.: 12/699,615

(22) Filed: Feb. 3, 2010

Related U.S. Application Data
(60) Provisional application No. 61/149,417, filed on Feb. 3, 2009.

(51) Int. Cl. G06Q 10/00; G06Q 50/00; G06Q 99/00

(52) U.S. Cl. 705/10; 705/348; 705/317; 705/301; 705/7

(57) ABSTRACT

A method of sustainability capital planning includes a first phase, a second phase, a third phase and a fourth phase. The first phase may include performing a business and environmental strategy analysis. The second phase may include performing a high level site and facility assessment. The third phase may include performing a strategic facility mapping process. The fourth phase may include performing a strategic facility planning process.

The present application claims priority to U.S. Provisional Application No. 61/149,417, filed on Feb. 3, 2009, which is incorporated herein by reference in its entirety.

### FIELD OF THE INVENTION

The present invention relates to evaluating benefits of sustainability improvements in construction projects generally and, more particularly, to a method and/or architecture for a sustainability capital planning tool.

### BACKGROUND OF THE INVENTION

Environmental sustainability has moved to the forefront of today's corporate strategy. Corporate sustainability brings new challenges to managing successful operations. A company's real estate portfolio is typically a tangible example of a corporation's commitment to sustainable practices. When it comes down to it, facilities are a key interaction between a corporation's environmental position and its customers, the public and employees. Corporate executives are faced with maximizing the use and value of facility assets. Executives must make decisions on how to best invest in corporate sustainability while understanding the opportunity cost of not embracing sustainable initiatives. The key strategic issues will be how to best align capital for sustainable projects with the vision, mission and strategies of the organization.

### SUMMARY OF THE INVENTION

The present invention concerns a method of sustainability capital planning includes a first phase, a second phase, a third phase and a fourth phase. The first phase may include performing a business and environmental strategy analysis. The second phase may include performing a high level site and facility assessment. The third phase may include performing a strategic facility mapping process. The fourth phase may include performing a strategic facility planning process.

The objects, features and advantages of the present invention include providing a sustainable capital planning tool that may (i) take clients' corporate strategic approach with their facilities and help them embrace being a green company, (ii) enable sustainability strategy development through alignment of facility cost and capital to the highest strategic use, (iii) analyze current and future business demands, (iv) develop a performance scorecard identifying key strategic issues driving corporate sustainability, (v) recommend capital improvements, (vi) measure facility conditions with respect to sustainable criteria, (vii) support development of site and facility initiatives scope, estimated capital cost, timing and potential cost benefit, (viii) evaluate and prioritize site and sustainable initiatives relative to strategic criteria, (ix) support development of guidelines for existing and new facility development, (x) support development of projected facility capital and cost plan, (xi) provide integration of Strategic Facility Analysis, Facility & Site Environmental Assessment and Sustainable Evaluation/Accreditation, (xii) identify business goals and key facility issues, and economic drivers according to a client's strategic plan, (xiii) establish a road map for short and long term facility development and financial expenditures fully utilize a client's facility budget and capital, and/or (xiv) provide a “green” roadmap for facilities and operations.

### BRIEF DESCRIPTION OF THE DRAWINGS

These and other objects, features and advantages of the present invention will be apparent from the following detailed description and the appended claims and drawings in which:

FIG. 1 is a flow diagram of an example first phase process in accordance with a preferred embodiment of the present invention;

FIG. 2 is a flow diagram of an example second phase process in accordance with a preferred embodiment of the present invention;

FIG. 3 is a flow diagram of an example third phase process in accordance with a preferred embodiment of the present invention;

FIG. 4 is a flow diagram of an example fourth phase process in accordance with a preferred embodiment of the present invention;

FIG. 5 is a diagram illustrating an example balance scorecard process in accordance with a preferred embodiment of the present invention;

FIGS. 6A-6E are diagrams illustrating LEED EB prerequisites analysis sheets and Sustainable Data Checklist in accordance with a preferred embodiment of the present invention;

FIGS. 7A-7C are diagrams illustrating business analyses in accordance with a preferred embodiment of the present invention;

FIG. 8 is a diagram illustrating an example business goals scorecard in accordance with a preferred embodiment of the present invention;

FIGS. 9A-9B are diagrams illustrating example business and facility alignment charts in accordance with a preferred embodiment of the present invention;

FIG. 10A is a diagram illustrating an example of strategic prioritization report in accordance with a preferred embodiment of the present invention;

FIG. 10B is a diagram illustrating details of the strategic prioritization report of FIG. 18;

FIG. 11 is a diagram illustrating an example SWOT analysis in accordance with a preferred embodiment of the present invention;

FIGS. 12A-12D are diagrams illustrating examples of a strategic facility mapping in accordance with a preferred embodiment of the present invention;

FIGS. 13A-13B are diagrams illustrating examples of strategic goals facility mapping in accordance with a preferred embodiment of the present invention;

FIGS. 14A-14E are diagrams illustrating examples of strategic financial mapping in accordance with a preferred embodiment of the present invention;

FIGS. 15A-15I are diagrams illustrating various parts of a strategic facility plan and a facility capital and cost plan generated using the tool in accordance with a preferred embodiment of the present invention;

Referring to FIGS. 16A-16B are diagrams illustrating various parts of a Facility Capital and Cost Plan generated using the Sustainable Capital Planning Tool in accordance with a preferred embodiment of the present invention;

FIG. 17 is a diagram illustrating an example of sustainable documentation generated in accordance with a preferred embodiment of the present invention; and

FIG. 18 is a diagram illustrating a system that may be used to implement methods in accordance with the present invention.

### DETAILED DESCRIPTION OF THE PREFERRED EMBODIMENTS

The present invention generally provides a tool that may be utilized by companies seeking to help clients become industry leaders by enabling sustainability strategy through aligning facility cost and capital to the highest strategic use. In one embodiment, the present invention generally provides a Sustainability Capital Planning Tool whose focus is on sustainability in facilities and environment. The tool generally allows a user (e.g., a firm engaged in architecture, engineering, planning, design, management, etc.) to take a client's corporate strategic approach with their facilities and help the client embrace being a “green” company. The Sustainability Capital Planning Tool in accordance with the present invention generally includes three major areas: a Business and Sustainability Strategy Analysis, a Site and Facility Sustainability Assessment, and a Corporate Sustainability Plan. The Business and Sustainability Strategy Analysis generally includes, but is not limited to reviewing strategic and business plans for sustainability drivers, analyzing current and future business demands, assessing policies and procedures, and developing a performance scorecard identifying key strategic issues driving corporate sustainability. The Site and Facility Sustainability Assessment may include, but is not limited to, collecting data on current facility and operational conditions, performing an initial review of current conditions and operations using sustainable criteria, recommending capital improvements, and measuring facility conditions with respect to sustainable criteria. The Corporate Sustainability Plan may include, but is not limited to, (i) development of site and facility initiatives scope, estimated capital cost, timing and potential cost benefit, (ii) evaluation and prioritization of site and sustainable initiatives relative to strategic criteria, (iii) development of guidelines for existing and new facility development, and (iv) development of a projected facility capital and cost plan.

To identify a path for utilization of a client's facilities, operations, and environment, the tool in accordance with the present invention may be used to facilitate integration of three major components: Strategic Facility Analysis, Facility and Site Environmental Assessment and Sustainable Evaluation/Accreditation. The Business Strategy Analysis generally identifies the business goals and key facility issues, and economic drivers according to the client's strategic plan. In one example, trained facility engineers and managers, while focusing on the corporate goals, may conduct an onsite Facility and Site Environmental Assessment. The Facility and Site Environmental Assessment may result in recommendations regarding repairs, and maintenance of building systems. The Facility and Site Environmental Assessment may also result in recommendations for sustainable operational practices.

Sustainable design criteria may be based, in one example, on an industry-accepted holistic green building rating system with an active third party review component. For example, the LEED Green Building Rating System administered by the U.S. Green Building Council, or the Green Globes System administered by the Green Building Initiative may be used. The LEED Green Building Rating System includes the entire family of rating systems, such as the LEED-EB for Existing Buildings, LEED-NC for New Construction, and LEED-CI for Commercial Interiors. The Green Globes System includes the entire family of rating systems, such as Green Globes for New Construction, and Green Globes for Continual Improvement of Existing Buildings.

For clients seeking to apply sustainable design principles to only a particular component of their facility, sustainable design criteria may be defined by a component rating system, such as the Energy Star label as administered by the Environmental Protection Agency, or Greenguard certification as administered by the Greenguard Environmental Institute. Application of this expertise to the facilities and operations along with incorporating the corporate goals is the third component that may be used to guide the client to implementing “Green” or sustainable accreditation.

A Business and Facility Alignment and Strategic Facility Mapping may be conducted by incorporating the “findings” (data and recommendations) from the Strategic Sustainable Process with input from the client. A final deliverable may include establishing a road map for short and long term facility development and financial expenditures fully utilizing a client's facility budget and capital (e.g., a “green” road map for facilities & operations).

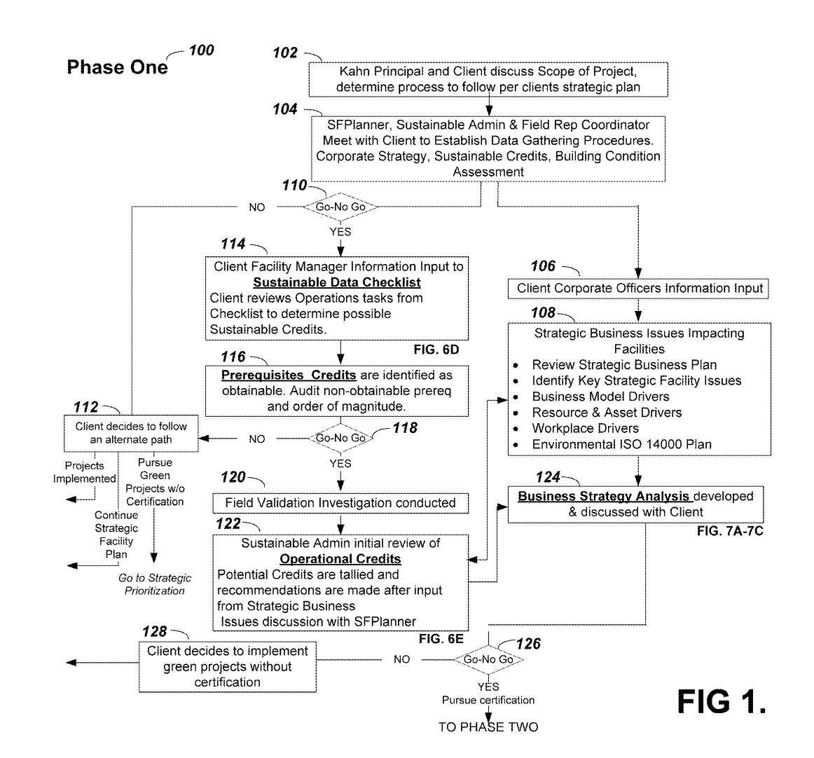

Referring to FIG. 1, a flow diagram is shown illustrating an example process 100 in accordance with a preferred embodiment of the present invention. The process 100 may be implemented as a first phase of a sustainable capital planning process (or tool). The first phase generally comprises a business and environmental strategy analysis. The tool user works with a client to gain an understanding of the client's business and environmental strategies and identify issues that have the greatest impact on existing facilities. The user may begin by reviewing with the client the strategic and business plans currently in place in order to understand the client's vision, mission, strategies and business goals. Each of the business goals may be organized and prioritized using a Balance Scorecard method of the tool to ensure that facility decisions are evaluated in a comprehensive context that is tied to the client's business.

The business and environmental analysis generally includes: identification of key business and environmental strategy milestones that sets the context for organizing and prioritizing business and facility concepts; an analysis of current and future business demand, translated into facility demand (e.g., provides a basis for facility utilization); identification of key LEED criteria that provide the client with the greatest return on investment and provide the greatest alignment to corporate strategy; assessment of current ISO 14000 impact statement that identifies current and future environmental goals and objectives; development of a Balance Scorecard that identifies the client's vision, mission, and key strategies, and organizes the client's business goals into customer value, financial goals, internal business process and employee enthusiasm goals; and business strategy mapping that clusters key business strategies relative to time and priorities.

The process 100 generally comprises a step (or block) 102, a step (or block) 104, a step (or block) 106, a step (or block) 108, a step (or block) 110, a step (or block) 112, a step (or block) 114, a step (or block) 116, a step (or block) 118, a step (or block) 120, a step (or block) 122, a step (or block) 124, a step (or block) 126, and a step (or block) 128. In one example, Phase 1 may be divided into Phase 1A, Phase 1B and Phase 1C. Phases 1B and 1C may be further divided into “strategic” and “Sustainable” portions. The strategic and sustainable portions of a phase may be performed simultaneously (e.g., carried out in parallel). Information may be exchanged between the strategic and sustainable portions of a phase, as necessary. Phase 1A may comprise steps 102 and 104. Phase 1B may comprise steps 106-122. The strategic portion of Phase 1B may comprise steps 106 and 108. The sustainable portion of Phase 1B may comprise the steps 110-116. Phase 1C may comprise steps 118-128. The sustainable portion of Phase 1C may comprise steps 118 and 122. The strategic portion of Phase 1C may comprise the steps 124-128.

When the client has decided to reach some level of sustainability in their corporation, application of the Sustainable Capital Planning Tool may begin with Phase 1A. In the step 102, an initial meeting between the client and a principal of the consulting company using the tool is held to discuss the corporation's strategic goals and determine the areas to pursue in regards of the facility and sustainability. In the step 104, the areas of focus identified in the initial meeting may be disseminated to other members of the consulting company (e.g., a Strategic Facilities Planner (SFPlanner), a Sustainable Administrator, and a Field Rep Coordinator). The Strategic Facilities Planner, Sustainable Administrator, and Field Rep Coordinator generally meet with the client and discuss and coordinate their tasks (e.g., establishing data gathering procedures). Phase 1B of the Sustainable Capital Planning Tool may then be started.

In step 106 of the strategic portion of Phase 1B, the client corporate officers share the strategic documents with the SFPlanner. In step 108, the SFPlanner who determines the Strategic Business Issues that impact the Facility (e.g., Strategic Business Plan, Key Strategic Facility Issues, Business Model Drivers, Resource and Asset Drivers, Workplace Drivers, Environmental ISO 14000 Plan, etc.).

During the Phase 1A meeting with the Sustainable Administrator and client, the criteria and resources are discussed as to what the initial impact will be to achieve certification through the selected green building rating system. In step 110 of the sustainable portion of Phase 1B, the client has a Go or No-Go decision to make. If the client's decision is “No-Go,” the process 100 moves to the step 112. In the step 112, the client may decide to follow an alternative path. There are 3 options: 1. Pursue “green” projects without getting a sustainable certification, 2. Follow the Strategic Facility Plan which will provide recommendations, prioritization and map out facility improvement spending, or 3. Make facility improvements by implementing immediate and necessary projects, in which case costs and timeline may be developed. If the decision to proceed is a “Go”, the process 100 proceeds to the step 114. In the step 114, the client's Facility Manager Information is input into a Sustainable Data Checklist of the tool. For example, the client reviews Operations tasks from the checklist to determine possible sustainable credits. The client reviews the Sustainable Data Checklist, prepared by the Sustainable Administrator. In the step 116, prerequisite credits are identified as obtainable. The non-obtainable prerequisites and order of magnitude are audited.

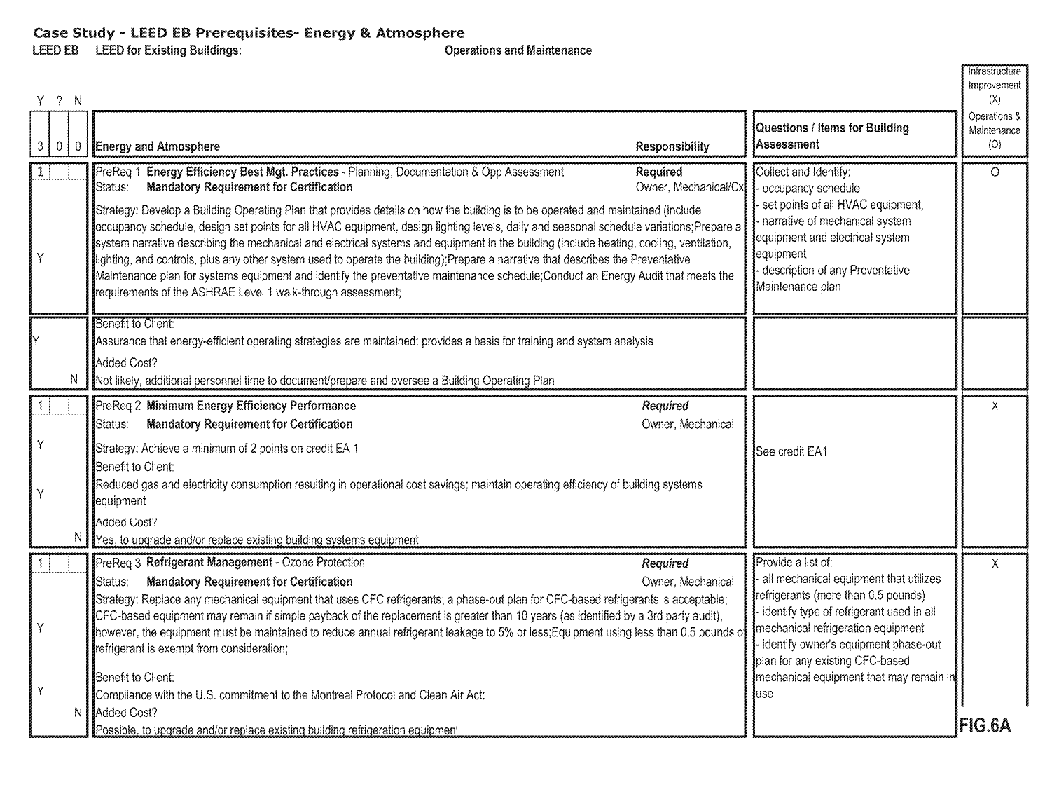

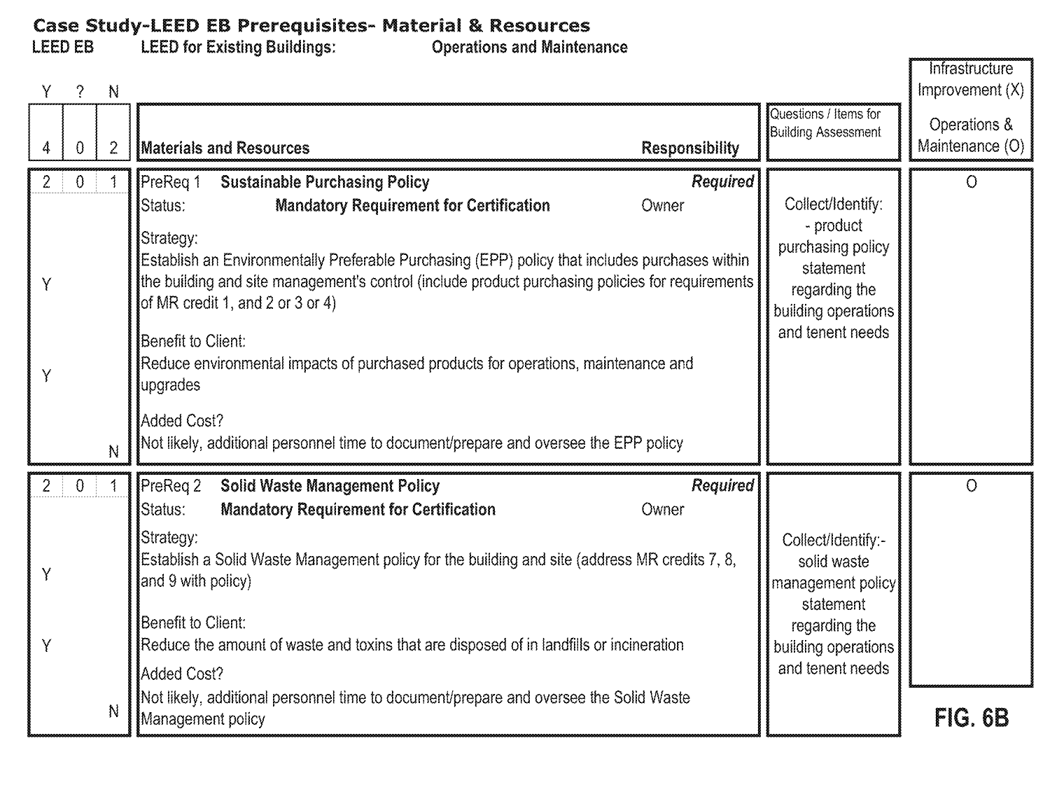

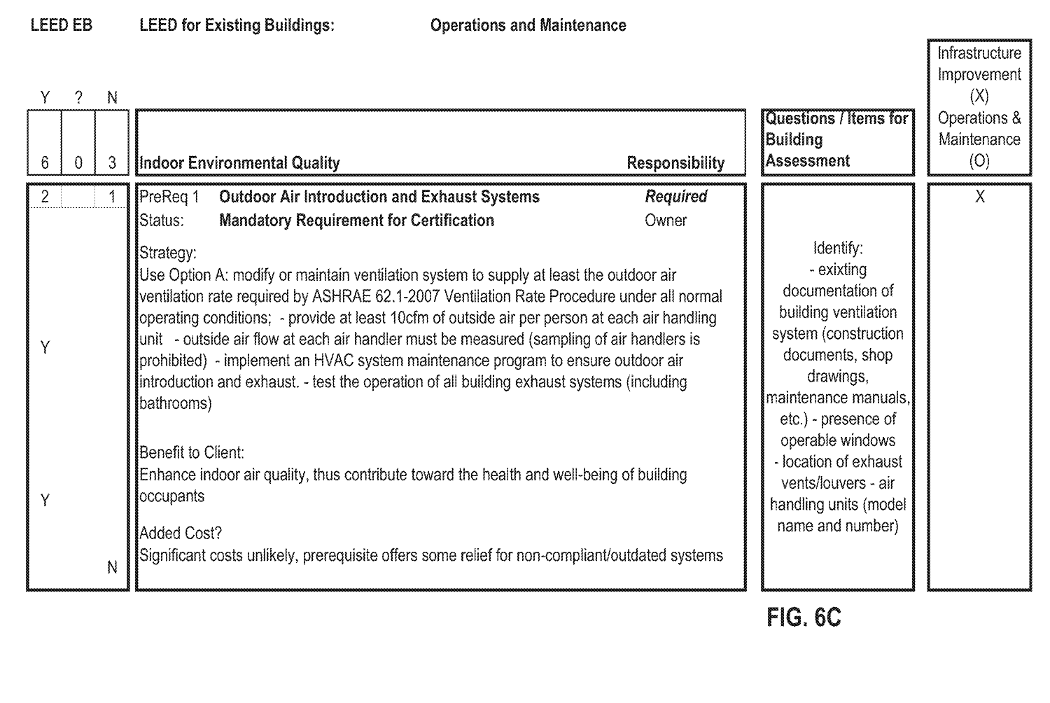

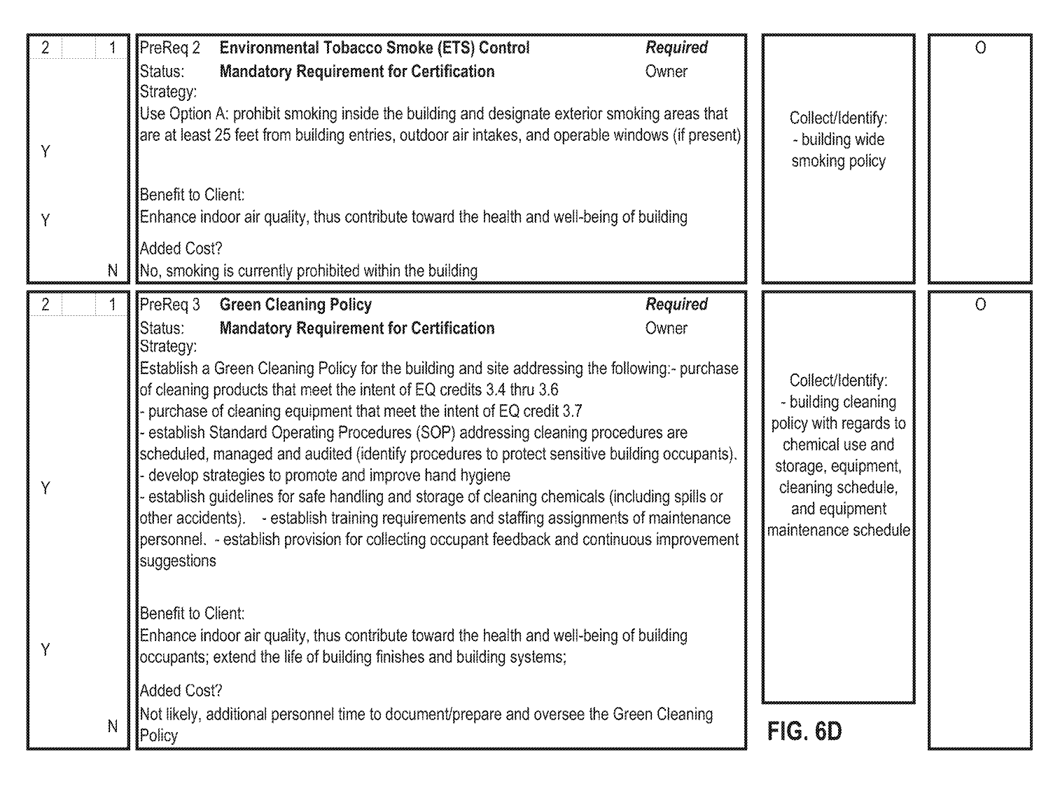

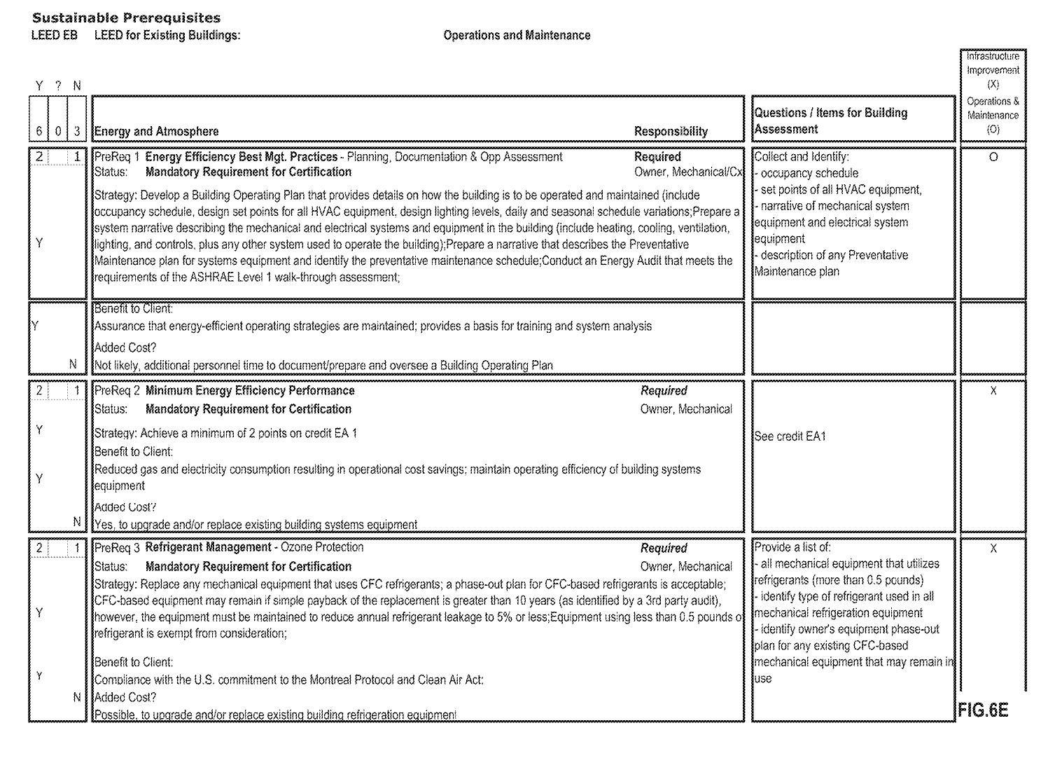

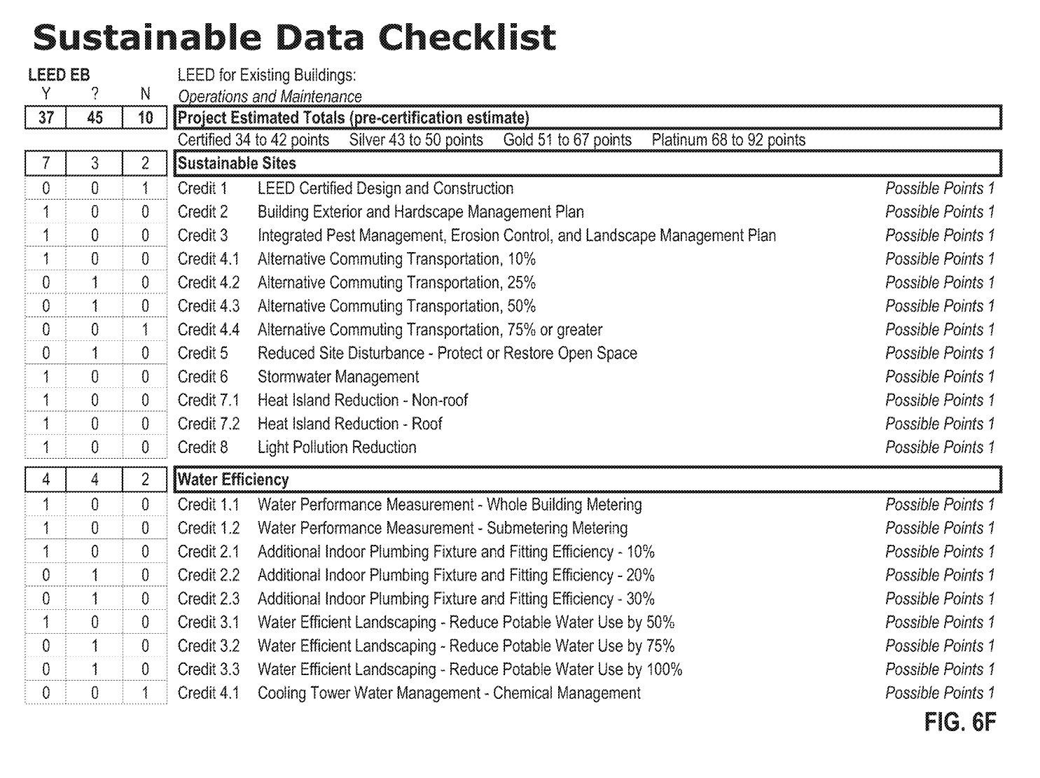

In one example, the Sustainable Data Checklist (an example of which is illustrated in FIG. 6E) may be implemented as a spreadsheet (e.g., implemented with Microsoft Excel; Microsoft and Excel are trademarks of Microsoft Corporation) that tallies the sustainable prerequisites and credits which identify the obtainable, possible, and non-obtainable/non-applicable credits. The spreadsheet generally is designed to prompt the user to enter the appropriate information and organizes the information for communication to other processes of the tool.

The Sustainable Capital Planning Tool then proceeds to Phase 1C. In the sustainable portion of Phase 1C, the focus of the Sustainable Administrator is the sustainable prerequisites; if a client cannot obtain all the prerequisites then the accreditation is not possible. In the step 118, the client is asked to make a Go/No-Go decision. Again, if the client's decision is “No-Go,” the process 100 moves to the step 112, where the client may decide among the 3 alternative paths: 1. Pursue “green” projects without getting a sustainable certification, 2. Follow the Strategic Facility Plan which will provide recommendations, prioritization and map out facility improvement spending, or 3. Make facility improvements by implementing immediate and necessary projects, in which case costs and timeline may be developed. If the decision to proceed is a “Go”, the client has agreed to do some type of “green” facility improvement from this point forward.

In the step 120, a field investigation may be made by the Sustainable Administrator to verify the prerequisites that have been tagged obtainable or completed, and identify the order of magnitude for completion for other prerequisites. In the step 122, the SFPlanner and the Sustainable Administrator collaborate and share their data to develop an initial review of the sustainable operational credits. This information may be used by the SFPlanner in Phases 1B & 1C.

In step 124 of the strategic portion of Phase 1C, the SFPlanner develops a Business Strategy Analysis by incorporating the strategic business issues and potential sustainable credits gathered when the Sustainable Administrator completed the field validation. In a work-session with the client, the team may use the Business Strategic Analysis module of the tool to review and collect data pertaining to the client's strategic and business plan. The Business Strategic Analysis module is designed to allow for the SFPlanner to input business goals. The tool prompts the SFPlanner to identify, for example, from a pre-selected menu whether the submitted goal is categorized as a Customer, Financial, Process or Employee related goal. Once the goal is categorized, the tool then prompts the SFPlanner to identify a numerical priority of the goal. The information is stored in the module for use in later processes. The findings are discussed with the client for accuracy. In step 126, the client makes a Go/No-Go decision. If the decision is “No-Go,” the process 100 moves to the step 128 where the client may implement the “green” projects with no intent to achieve a sustainable certification. If the decision is “Go,” the Sustainable Capital Planning Tool continues to a second phase to pursue certification.

The process 100 may generate a number of deliverables for the client. In one example, the deliverables may comprise (i) key business and environmental strategy milestones, (ii) current and future facility demand, (iii) identification of key LEED criteria, (iv) assessment of the client's current ISO 14000 Impact Statement, (v) a balanced scorecard, and (vi) a business strategy map. The deliverables may be presented to the client, for example, as a hard copy report or an electronic report (e.g., in a document file or slide presentation) that may be displayed to the client.

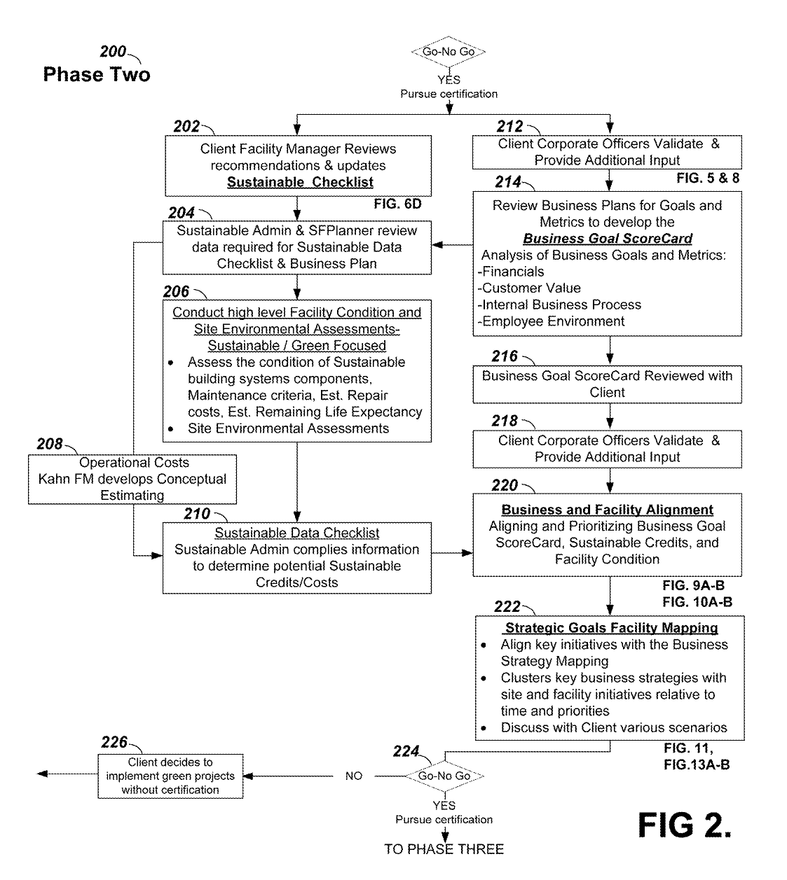

Referring to FIG. 2, a flow diagram is shown illustrating an example process 200 in accordance with a preferred embodiment of the present invention. The process 200 may be implemented as a second phase of a sustainable capital planning process. The second phase generally provides for high level site and facility assessment. The tool user works with the client's operation staff to assess current conditions and operations of sites and facilities. An initial data collection effort is conducted that is designed to collect existing data on current site and facilities. The data collected may include, but is not limited to, site and facility plans, past facility and environmental studies, and facility management operations. When the data has been collected and synthesized, onsite walkthrough of existing facilities may be conducted. An interview session with key operation staff may also be conducted to gain further insight on existing conditions.

When the assessments are complete, an analysis may be made of the findings of the site and environment assessment relative to the LEED and ISO 14000 criteria established in Phase 1. Based on results of the analysis, the findings may be organized into a Strength, Weakness, Opportunity and Threat (SWOT) analysis. Recommendations may be made and key facilities initiatives that will provide the client with the greatest return relative to the goals and objectives set in the environment strategy may be prioritized.

The high level site and environment assessment may include, but is not limited to: (i) collection of data on current conditions including, but not limited to site and facility plans, facility management operations data, previous reports, studies and initiatives; (ii) site assessment including, but not limited to current infrastructure, soils, hydrology and drainage, existing structures, circulation and parking; (iii) facility assessment including, but not limited to current space use, architectural systems, mechanical and electrical systems; (iv) facility operations assessment including, but not limited to current facility maintenance procedures, waste management and energy management; (v) environmental compliance assessment that addresses the applicability of regulations (e.g., Clean Air Act, Clean Water Act, Resource Conversion and Recovery Act, Hazardous and Solid Waste Liability Act, Superfund Amendments and Reauthorization Act, Toxic Substance Control Act, and applicable sections of the Natural Resource and Environmental Protection Act, etc.); (vi) categorization of site and facility issues into SWOT Categories (e.g., Strengths, Weakness, Opportunities, and Threats) with assessment of Risk and priorities relative to issues identified in assessments. The deliverables of the Phase 2 process may include: site assessment; facility assessment; facility operations assessment; environmental compliance assessment; SWOT analysis of site and facility issues. In one example, the deliverables of Phase 2 may be provided to the client as a hard copy report or an electronic presentation (e.g., a document file or slide presentation).

The process 200 generally comprises a step (or block) 202, a step (or block) 204, a step (or block) 206, a step (or block) 208, a step (or block) 210, a step (or block) 212, a step (or block) 214, a step (or block) 216, a step (or block) 218, a step (or block) 220, a step (or block) 222, a step (or block) 224, and a step (or block) 226. In one example, Phase 2 may be divided into “strategic” and “sustainable” portions. The strategic and sustainable portions of phase 2 may be performed simultaneously (e.g., carried out in parallel). Information may be exchanged between the strategic and sustainable portions of phase 2, as necessary. The strategic portion of Phase 2 may comprise steps 202-210. The sustainable portion of Phase 2 may comprise the steps 212-222.

When the client has agreed to pursue certification, the Sustainable Capital Planning Tool moves to Phase 2. The sustainable portion of Phase 2 begins with step 202. In step 202, the client's Facility Manager reviews the recommendations for potential sustainable credits made by the Sustainable Administrator and updates the Sustainable Data Check list with any existing documentation or other criteria relevant to the certification process. In the step 204, the Sustainable Administrator and SFPlanner review and share the information obtained in the Sustainable Data Checklist and Business Plan, respectively. The SFPlanner has developed the Business Goal Score Card (described below in connection with step 214 in the strategic portion of Phase 2) at this point.

In step 206, the Field Rep Coordinator assembles the team of Facility Engineer Assessors to conduct a high level Facility Condition and Site Environmental assessment. The mechanical/electrical components of the facility are inspected by the Facility Engineer Assessors to determine the condition of the building(s). The resulting Facility Condition Assessment will include an assessment of the building site components, any maintenance concerns or requirements, a list of recommended repairs and/or other remediation requirements, and includes an estimate of associated replacement and repair costs. The Facility Engineer Assessors comments and photographs are also included in this document. The components of the assessment may be organized by CSI format and may include building systems of each building space assessed. If desired, the components may also be organized by the corporate strategic plan and by associated Sustainable Data credits.

The client's deliverable is the Facility Condition Assessment Report. This report can be sorted by various criteria, including Sustainable Data credits with descriptions. In step 208, the Facility Management Team develops a cost estimate on the operational improvements using the information from the SFPlanner and the Sustainable Administrator during the same time frame as the Facility Condition Assessment is being conducted. In step 210, the Sustainable Administrator compiles information to determine potential Sustainable Credits/Costs into the Sustainable Data Checklist. The information exchange is conducted between the SFPlanner, Sustainable Administrator and the Facility Management Team to develop data for the Business and Facility Alignment module (described below in connection with the strategic portion of the Phase 2 process).

The strategic portion of the Phase 2 process generally begins with step 212. In step 212, the client corporate officers validate the Business Strategic Analysis and make any adjustments (e.g., provide additional information). In step 214, the SFPlanner analyses the Strategic Business goals using, for example, four criteria (e.g., Financials, Customer Values, Internal Business Process and Employee Environment). When the business goals have been identified, entered, categorized and prioritized with the client, the tool produces an output report named the Business Goals Scorecard. In step 216, the Business Goals Scorecard is reviewed with the client and modification may be made. The information may be shared with the Sustainable Administrator (See above in connection with the description of the sustainable portion of Phase 2).

After the Business Goals Scorecard is reviewed in step 216, the sustainable portion of the process 200 continues with step 218. In step 218, the client's corporate officers validate and provide additional input as needed. In step 220, the data is entered into, for example, a spreadsheet (e.g., implemented with Microsoft Excel; Microsoft and Excel are trademarks of Microsoft Corporation) of the Business and Facility Alignment module that aligns and prioritizes the three components; Strategic Business Analysis, Sustainable Credits, and Facility Condition Assessment. In one example, the Business and Facility Alignment module may be implemented as a form designed to align the input of sustainable facility improvement projects and business goals identified in the Business Strategy Analysis module. The spreadsheet generally is designed to prompt the user to enter appropriate information and organizes the information for communication to other processes of the tool.

In one example, the form prompts the SFPlanner to enter a defined improvement project recognized by conducting the Facility Condition Assessment. Each improvement project “assessment” is converted to a rating scale when enter into the Business and Facility Alignment module of the tool. Then, within the form, the SFPlanner aligns the business goals, category (e.g., Customer, Financial, Process, Employee) and the improvement projects. The tool then prompts the SFPlanner to enter the assessed condition value. The present invention generally uses the spreadsheet program to transform the real world data (e.g., the facility condition assessment), which may be in a stand alone deliverable, into a metric system by item to facilitate importation into the Business and Facility Alignment tool. The spreadsheet is generally designed to utilize (leverage) the particular expertise and knowledge of the user to perform the transformation of the facility condition assessment (e.g, prompting the user for the assessed condition value of the data). After the data inputs and SFPlanner evaluations have been entered, a report is generated that shows each facility improvement project, its condition value, and which projects align to the business goals.

When the data has been entered into the Business and Facility Alignment module, the SFPlanner runs a prioritization analysis of the data. The Business and Facility Alignment module runs a quadrant analysis that maps and prioritizes facility projects identified in the facility assessment. The output categorizes the facility improvement projects into 1) Projects that should received capital priority, 2) Projects that should be evaluated on a business case analysis basis and 3) Projects that require no capital investment. In step 222, these scenarios are discussed with the client for any changes in prioritization. In step 224, the client makes a Go/No-Go decision. If the decision is “No-Go,” the client may implement the “green” projects with no intent to achieve sustainable certification. If the decision is “Go”, the client agrees to continue pursuing certification and the Sustainable Capital Planning Tool advances to Phase 3.

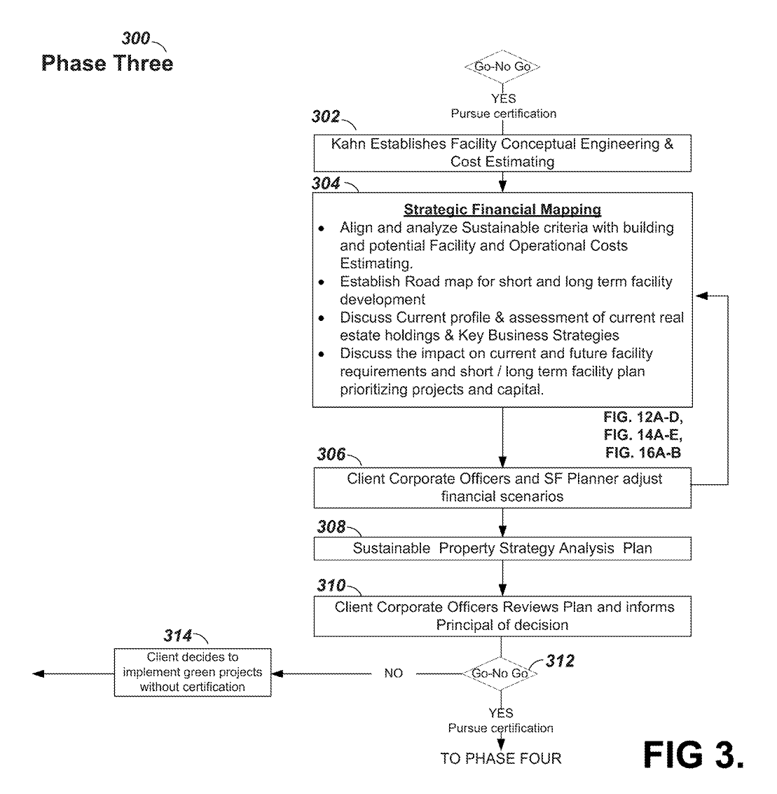

Referring to FIG. 3, a flow diagram is shown illustrating an example process 300 in accordance with a preferred embodiment of the present invention. The process 300 may be implemented as a third phase of a sustainable capital planning process. The third phase generally provides for strategic facility mapping. When the high level site and facility assessment is complete, the tool user works with the client to scope, cost and further prioritize site and facility initiatives that best align criteria and objectives set in Phase 1. The initial phase takes the recommendations from Phase 2 and further defines each initiative relating to the scope, capital cost and potential opportunities.

When the initiatives have been scoped, each is evaluated against the criteria and goals set in the Balance Scorecard in Phase 1. The goal of the approach in Phase 3 is to align the site and facility initiatives identified in Phase 2 to the client's business strategies and goals and to further prioritize the identified initiatives. Based on the final prioritized list of site and facility initiatives, an interactive strategic mapping work session is conducted with the client. The interactive strategic mapping work session is designed to align key initiatives with the Business Strategy Mapping completed in Phase 1. The goal is to cluster key business strategies with site and facility initiatives relative to time and priorities and provide the client with a strategic road map for accomplishing its business and environmental strategy. The Phase 3 process includes, but is not limited to: developing site and facility scope, capital cost, timing and potential cost benefits; evaluating and prioritizing site and facility initiatives relative to Balance Scorecard criteria; clustering key business strategies with site and facility initiatives relative to time and priorities. The deliverables of the Phase 3 process may include: site and facility initiative scope, capital cost and timing; Balance Scorecard evaluation; strategic facility map. In one example, the deliverables of Phase 3 may be provided to the client as a hard copy report or an electronic presentation (e.g., a document file or slide presentation).

The process 300 generally comprises a step (or block) 302, a step (or block) 304, a step (or block) 306, a step (or block) 308, a step (or block) 310, a step (or block) 312, and a step (or block) 314. In Phase 3, the client has agreed to pursue certification and the project team determines which certification level is realistic to pursue (e.g., Certified, Silver, Gold, Platinum). In step 302, Estimators establish the facility conceptual engineering and cost estimating for the key improvement projects that will be necessary to reach the corporate strategic goals and sustainable certification. In step 304, the cost estimating along with a time frame for work completion is entered in to a spreadsheet (e.g., implemented with Microsoft Excel; Microsoft and Excel are trademarks of Microsoft Corporation) called the Strategic Financial Mapping module. From the Strategic Financial Mapping module the Financial Analysis report is produced. The Financial Analysis report aligns and analyzes the sustainable criteria and establishes a road map for short and long term facility development.

In the Strategic Financial Mapping module the key improvement projects that have been identified as Capital Priorities or Business Case Analyses may be transferred to a project input sheet. The project input sheet prompts the SFPlanner to enter the cost of the project, the expected return, and the timing of the investment. The Financial Analysis report may be implemented, in one example, as a cash flow model that shows the outlay of capital and the expected economic benefit over the expected time. The Financial Analysis report allows the SFPlanner to evaluate the return on investment, payback periods and net present value. The Financial Analysis report is an interactive report that allows the SFPlanner to change variables to allow for different outcomes.

In step 306, the client's corporate officers and the SFPlanner may adjust the financial scenarios as they see fit. In step 308, the final deliverable of this phase, the Sustainable Property Strategy Analysis Plan, is generated. The Sustainable Property Strategy Analysis Plan generally includes the findings from three components: Strategic Business Analysis, Sustainable Credits and Facility Condition Assessment. In step 310, the client's corporate officers review the plan in order to make a Go/No-Go decision. In the step 312, the client's corporate officers inform the principal of their decision. If the decision is “No-Go,” the client has decided to implement green projects without certification (e.g. step 314). If the decision is to “Go,” the client has decided to continue pursuing certification and Phase 4 of the Sustainable Capital Planning Tool is entered.

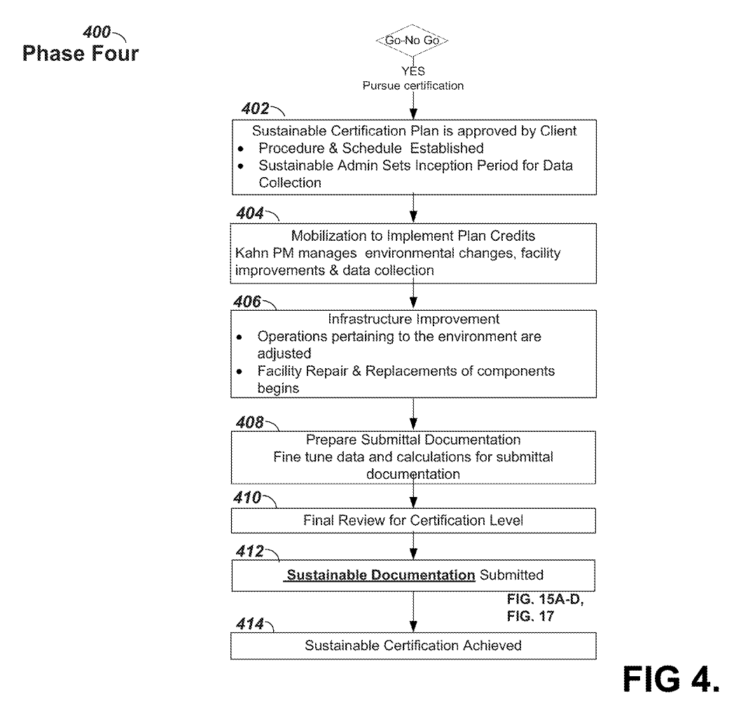

Referring to FIG. 4, a flow diagram is shown illustrating an example process 400 in accordance with a preferred embodiment of the present invention. The process 400 may be implemented as a fourth phase of a sustainable capital planning process. The fourth phase generally provides a Strategic Facility Plan. The information developed in Phases 1 through 3 may be synthesized and the Strategic Facility Plan is developed. The Strategic Facility Plan may be used by the client as a road map for short and long term facility development. The Strategic Facility Plan provides the client with a current profile and assessment of the client's current real estate holdings, key business strategies and the impact on current and future facility requirements and a phase short and long term facility plan that prioritizes projects and capital. The Strategic Facility Plan may provide feed into the capital planning and budget forecasting process plus provide an actionable plan for ISO 14000 compliance and LEED certifications. The process of Phase 4 generally provides deliverables that include: facility vision, mission, and key strategies; current real estate profile and condition; ISO 14000 and LEED compliance plans; project implementation plan; projected facility capital and cost plan. In one example, the deliverables of Phase 4 may be provided to the client as a hard copy report or an electronic presentation (e.g., a document file or slide presentation).

The process 400 may comprise a step (or block) 402, a step (or block) 404, a step (or block) 406, a step (or block) 408, a step (or block) 410, a step (or block) 412, a step (or block) 414. Phase 4 of the sustainable capital planning process provides for implementation of Sustainable Certification. At this point the client has agreed to pursue sustainable certification. In step 402, a Sustainable Certification Plan is developed and approved by client. The procedure and schedule is established and the inception period is set for additional data collection (some data was already gathered during the Facility Condition Assessment) and credit preparation. In step 404, the Project Management Team manages environmental changes, facility improvements and data collection. The information is shared with the Sustainable Administrator. In step 406, infrastructure improvement is started. Operation pertaining to the environment may be adjusted and key improvements projects (e.g., facility repairs, replacement of components, and alterations) which were prioritized in the Strategic Financial Mapping module are started. The environmental operational adjustments are made and documented.

In step 408, the Sustainable Administrator prepares the documentation for the sustainable certification submittal. The data and calculations are fine tuned. In step 410, a final review of the certification level is held. In step 412, the sustainable documentation is submitted to the appropriate certification organization. The Sustainable Administrator oversees the submittal process, including addressing any clarification requests and/or any necessary appeals. In step 414, the “Green” or sustainable accreditation is awarded.

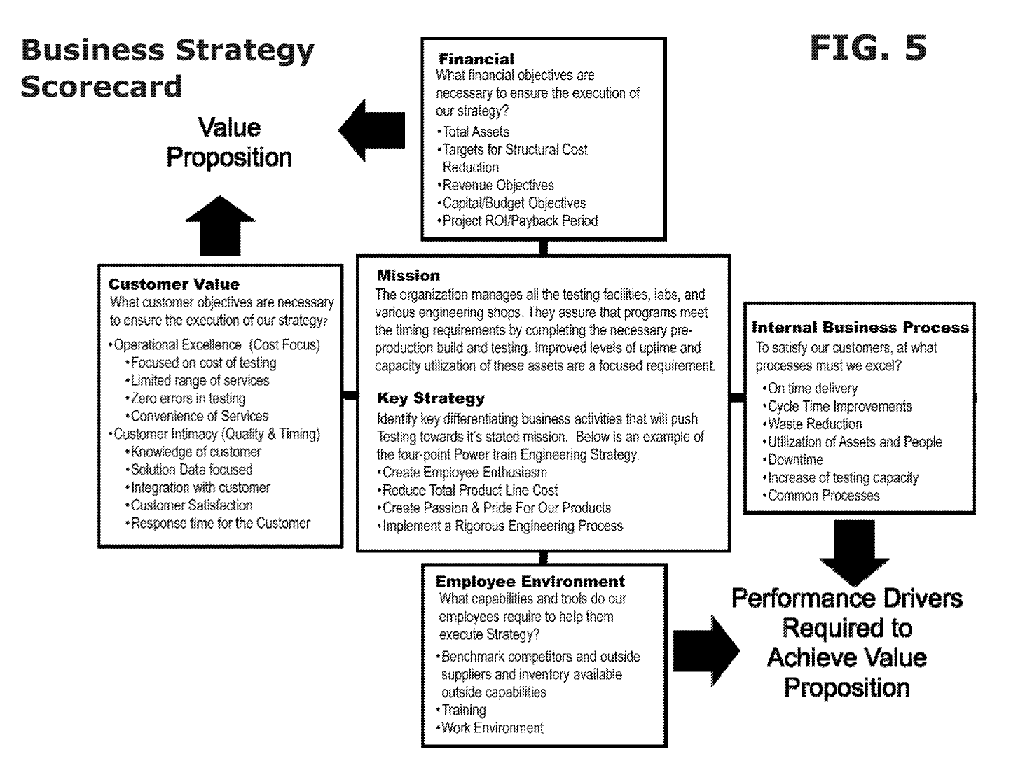

Referring to FIG. 5, a diagram is shown illustrating an example balance scorecard process in accordance with a preferred embodiment of the present invention. The Balance Scorecard is developed in Phase 1. The Balance Scorecard identifies the client's vision, mission, and key strategies, and organizes the client's business goals into customer value, financial goals, internal business process and employee enthusiasm goals. The Phase 3 process generally includes evaluating and prioritizing site and facility initiatives relative to the Balance Scorecard criteria.

Referring to FIGS. 6A-6E, diagrams are shown illustrating LEED EB prerequisites analysis sheets and Sustainable Data Checklist in accordance with a preferred embodiment of the present invention. The LEED EB prerequisites and Sustainable Data Checklist are identified and/or developed in Phase 1.

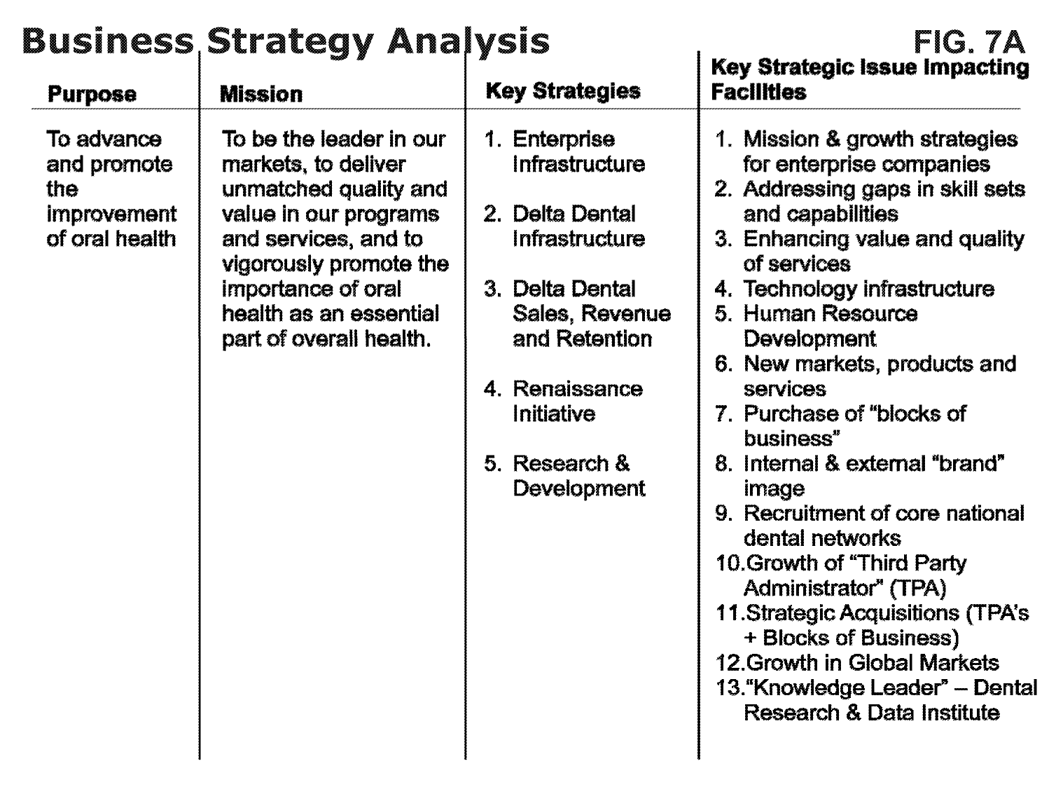

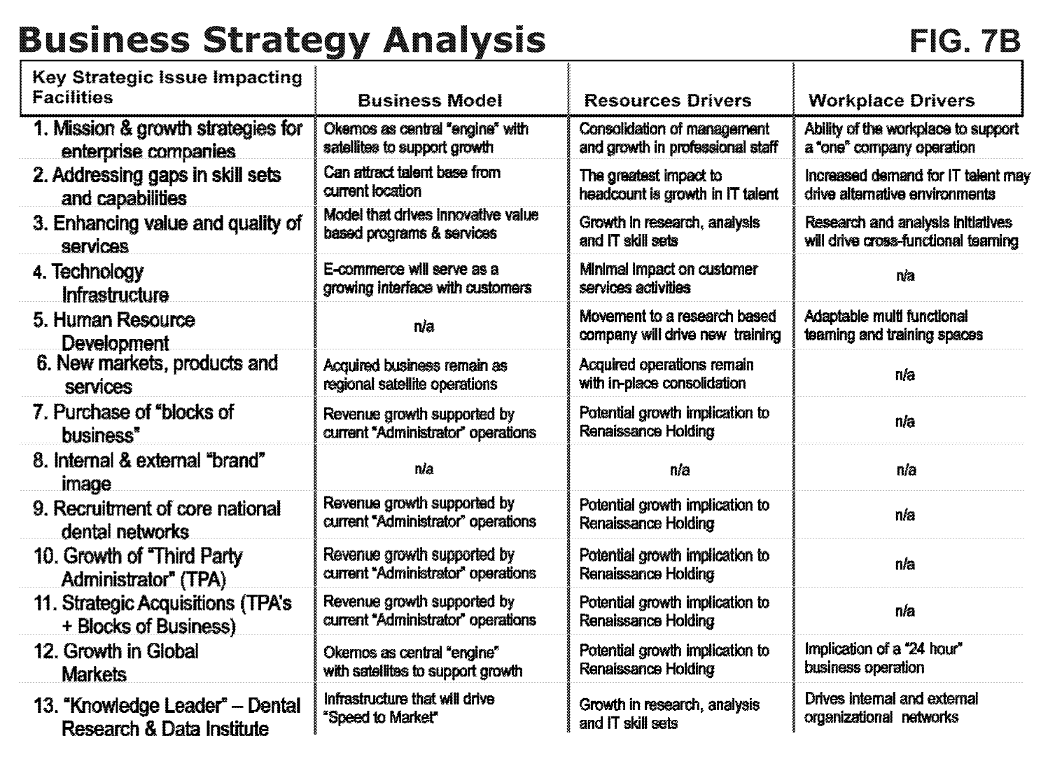

Referring to FIGS. 7A-7C, diagrams are shown illustrating examples of a business analysis deliverable in accordance with a preferred embodiment of the present invention.

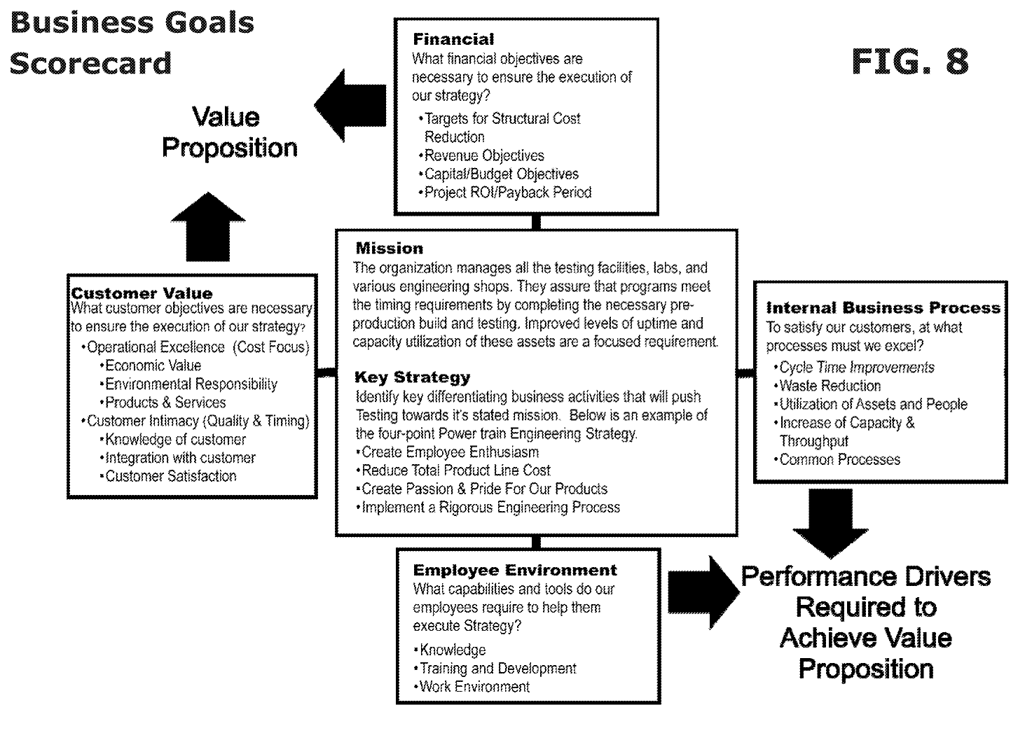

Referring to FIG. 8, a diagram is shown illustrating an example Business Goals Scorecard deliverable in accordance with a preferred embodiment of the present invention. During Phase 2, when the business goals have been identified, entered, categorized and prioritized with the client, the tool produces an output report named the Business Goals Scorecard. The Business Goals Scorecard is reviewed with the client and modification may be made.

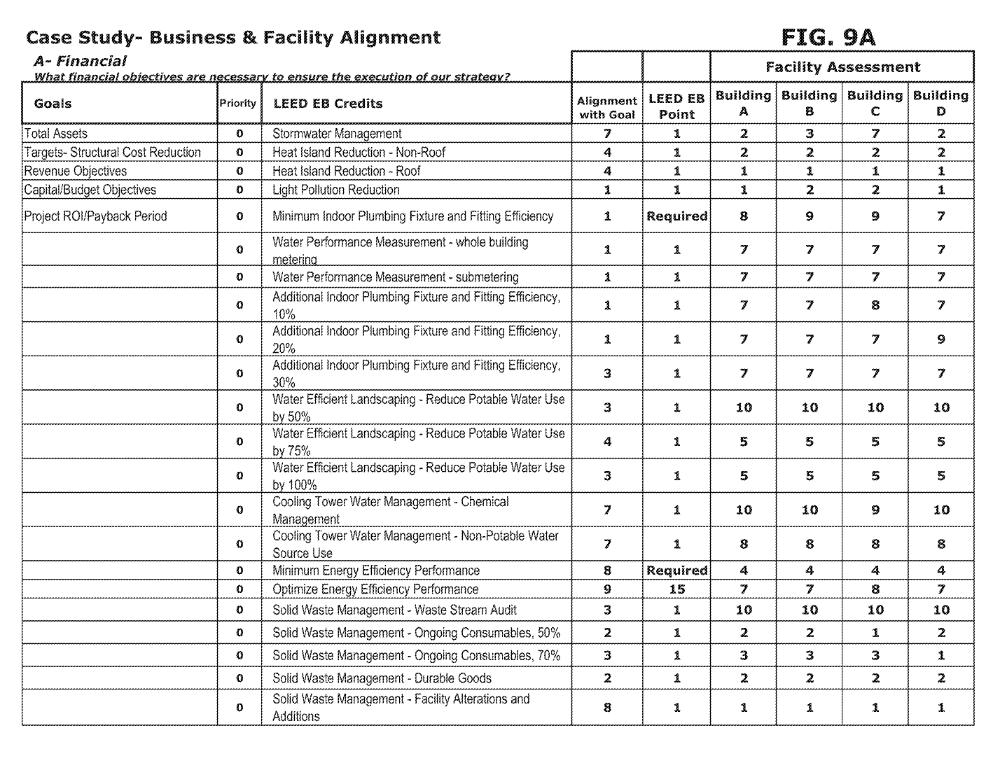

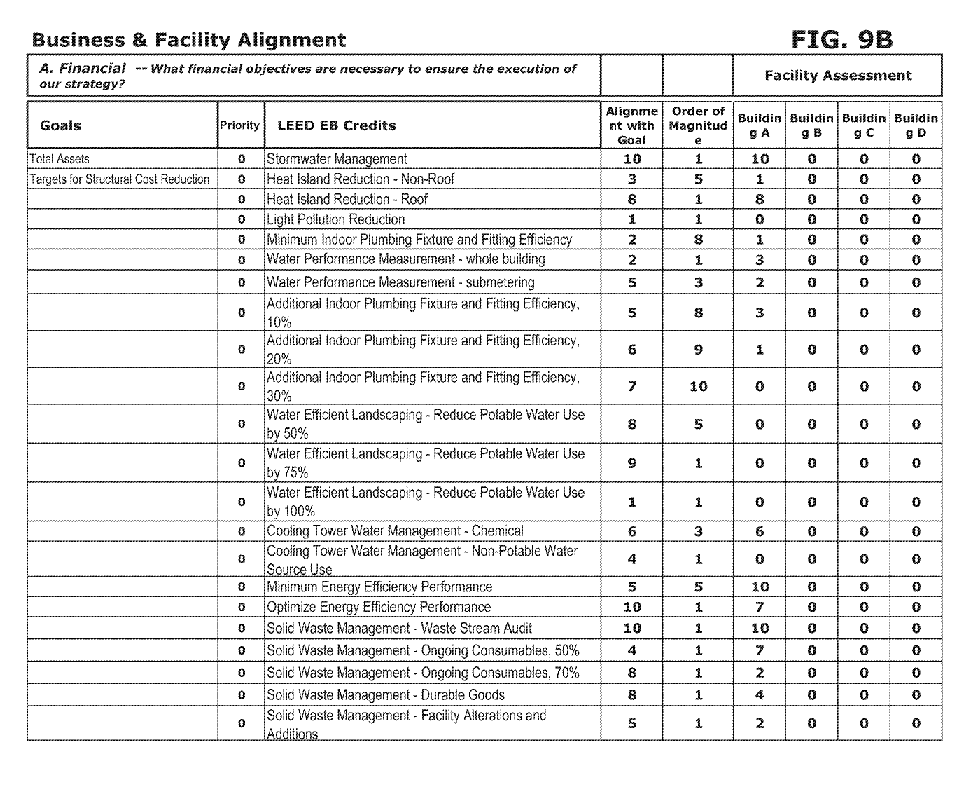

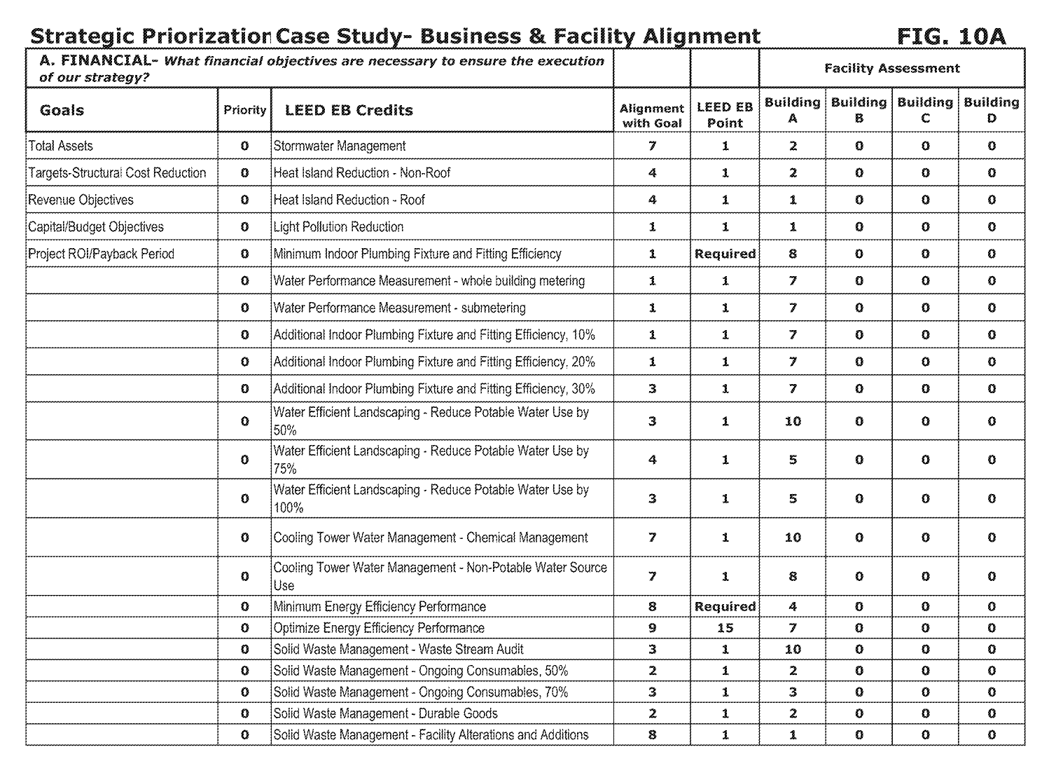

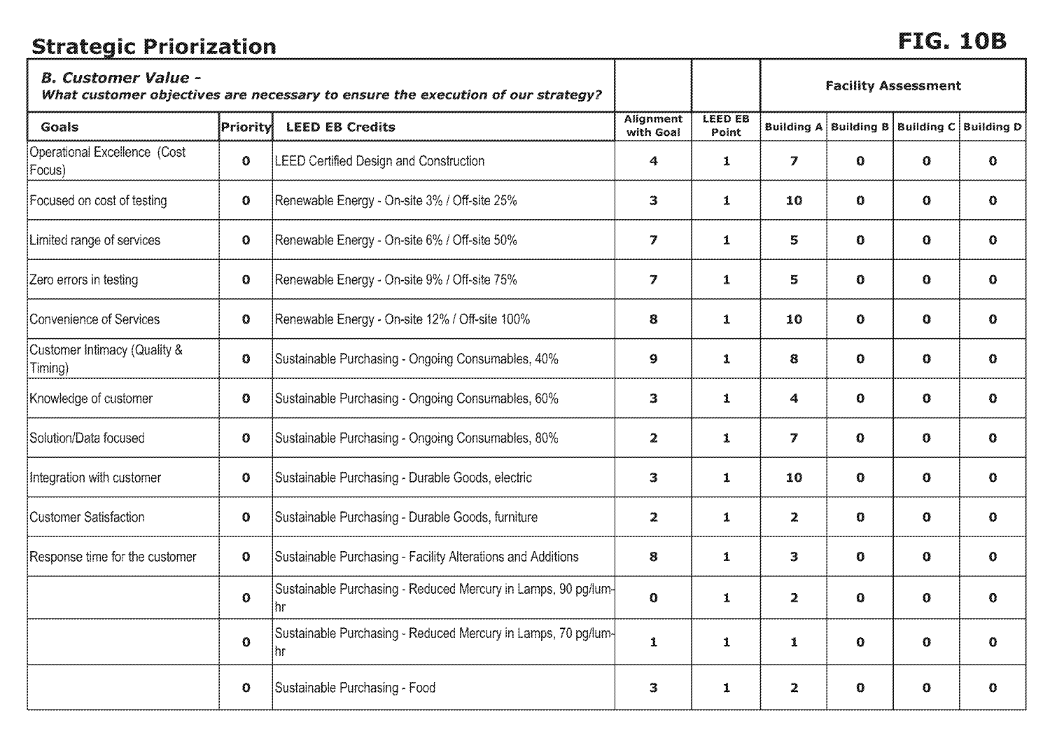

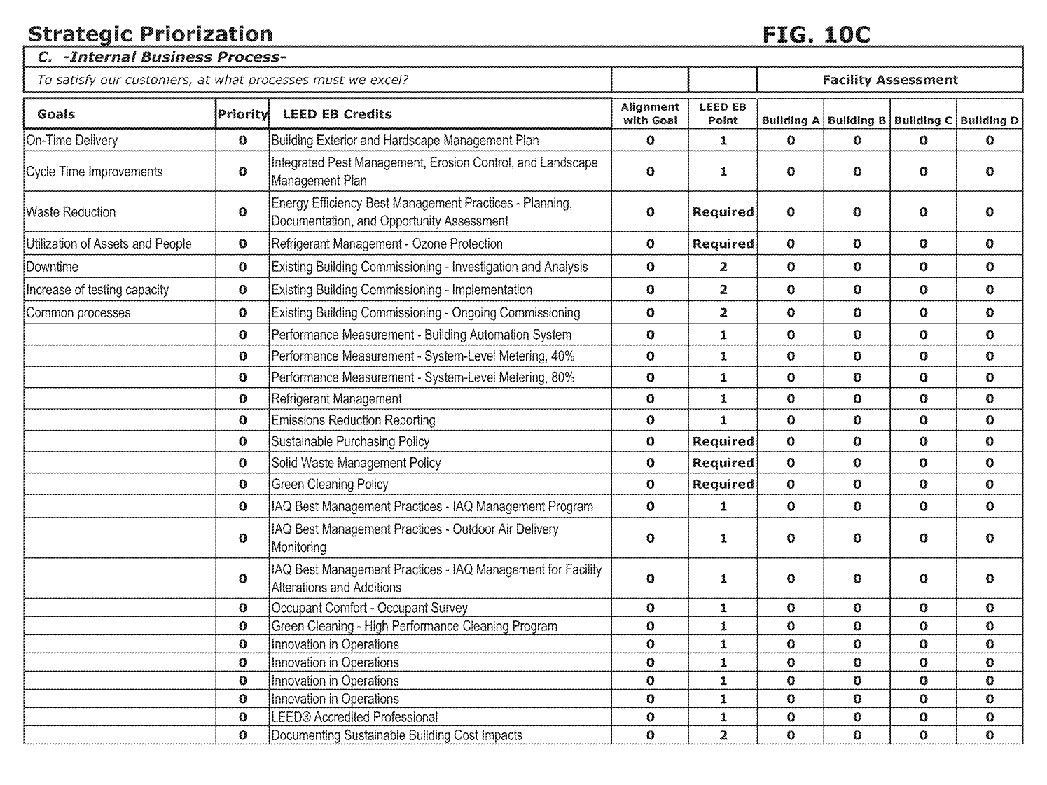

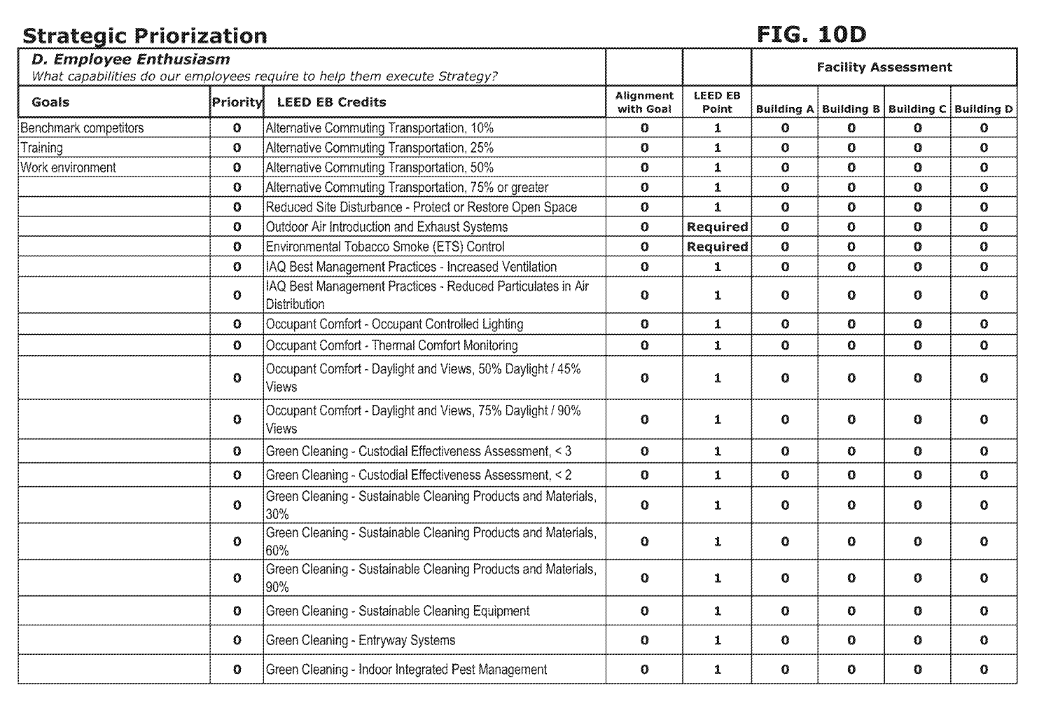

Referring to FIGS. 9A-9B, diagrams are shown illustrating example business and facility alignment charts in accordance with a preferred embodiment of the present invention. During Phase 2, when the data has been entered into the Business and Facility Alignment module, the SFPlanner runs a prioritization analysis of the data. The Business and Facility Alignment module runs a quadrant analysis that maps and prioritizes facility projects identified in the facility assessment. The output categorizes the facility improvement projects into 1) Projects that should received capital priority, 2) Projects that should be evaluated on a business case analysis basis and 3) Projects that require no capital investment. FIG. 10A shows a diagram illustrating an example of strategic prioritization report in accordance with a preferred embodiment of the present invention. FIG. 10B shows a diagram illustrating details of the strategic prioritization report.

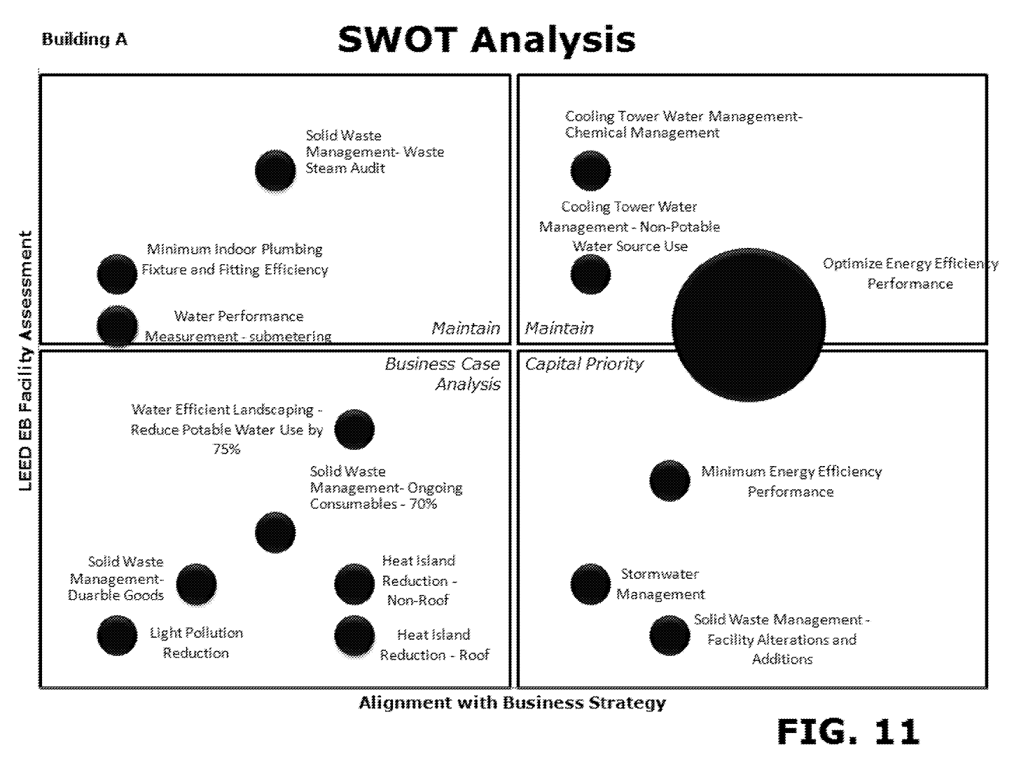

Referring to FIG. 11, a diagram is shown illustrating an example SWOT analysis in accordance with a preferred embodiment of the present invention. The SWOT analysis diagram is a deliverable of Phase 2. The SWOT analysis diagram generally provides a visual representation of the categorization of site and facility issues into SWOT Categories (e.g., Strengths, Weakness, Opportunities, and Threats) with assessment of Risk and priorities relative to issues identified in assessments.

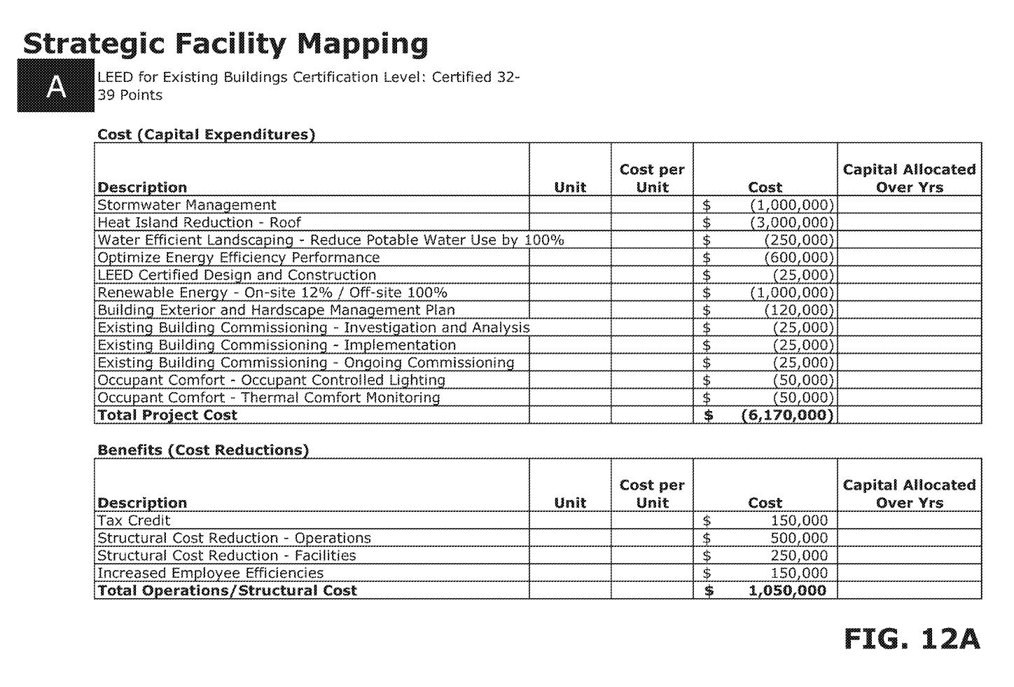

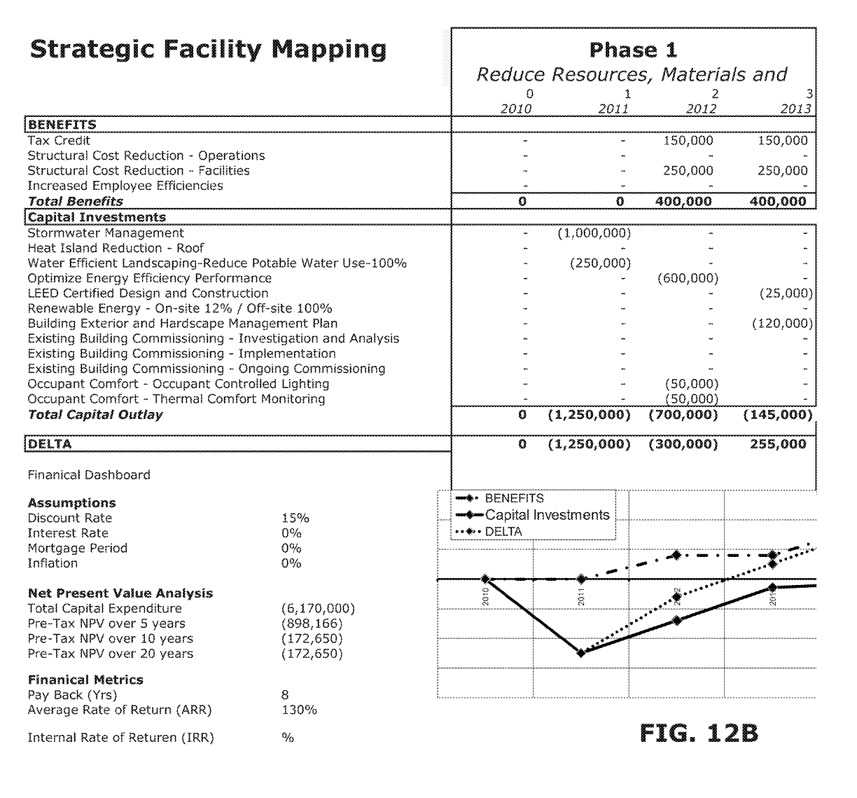

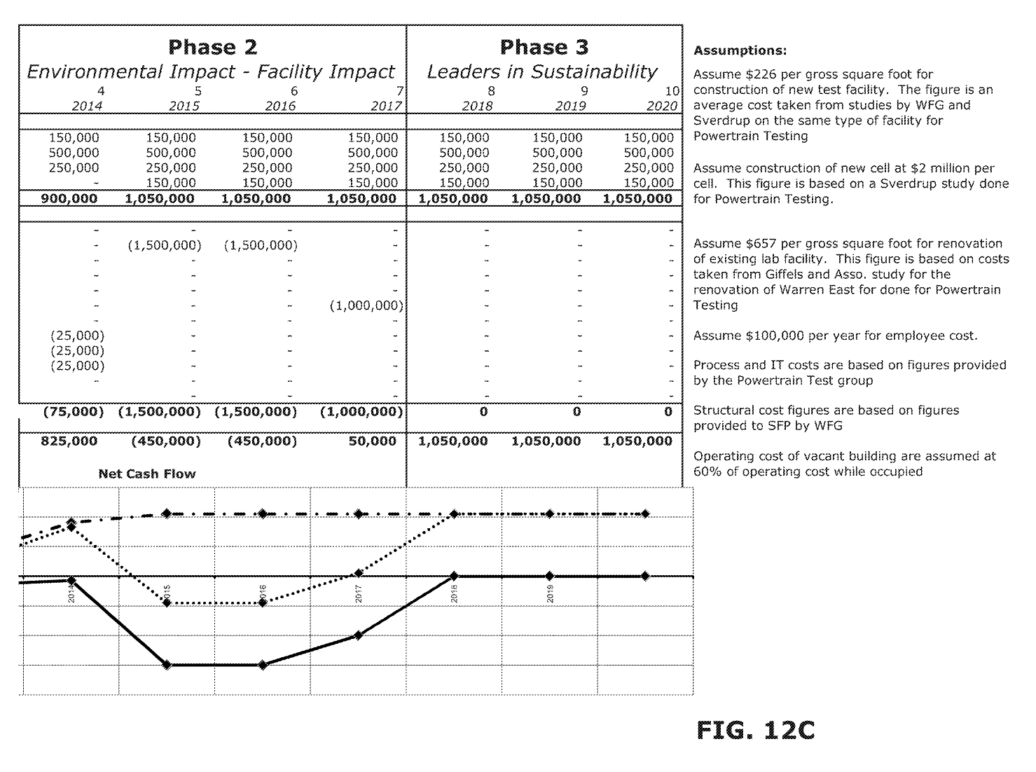

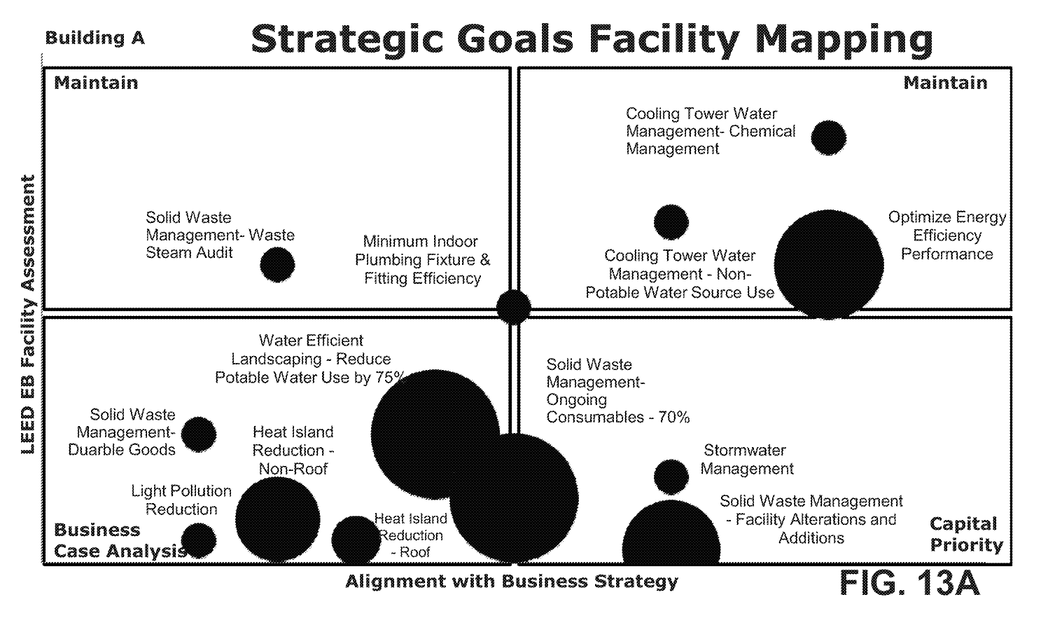

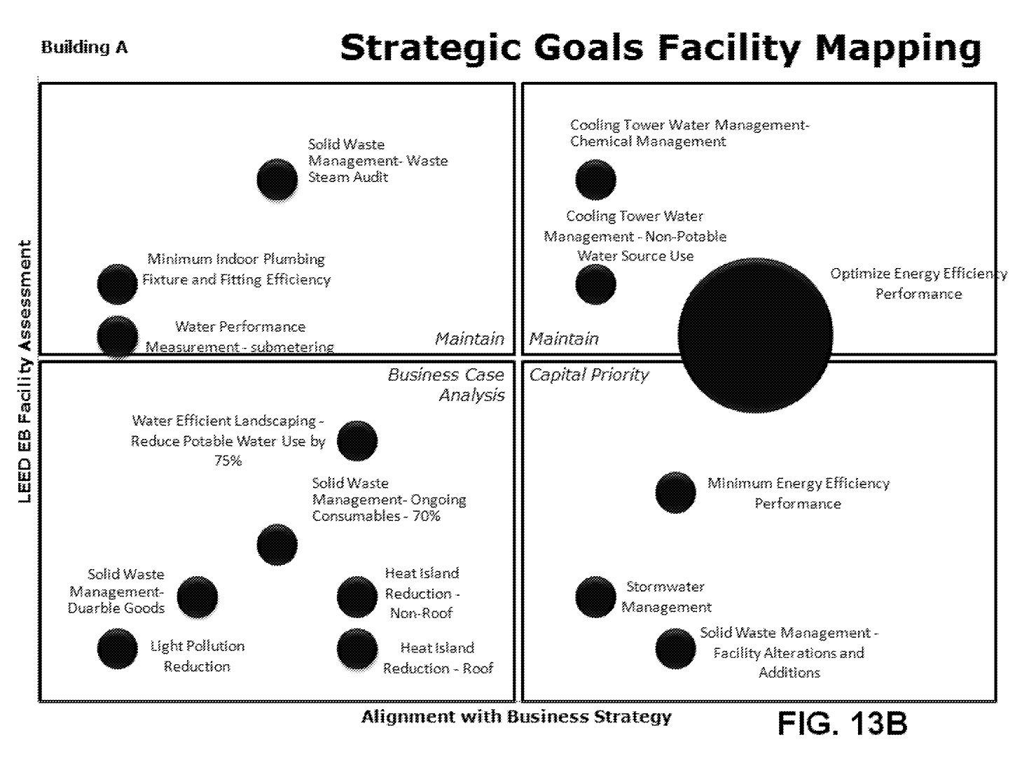

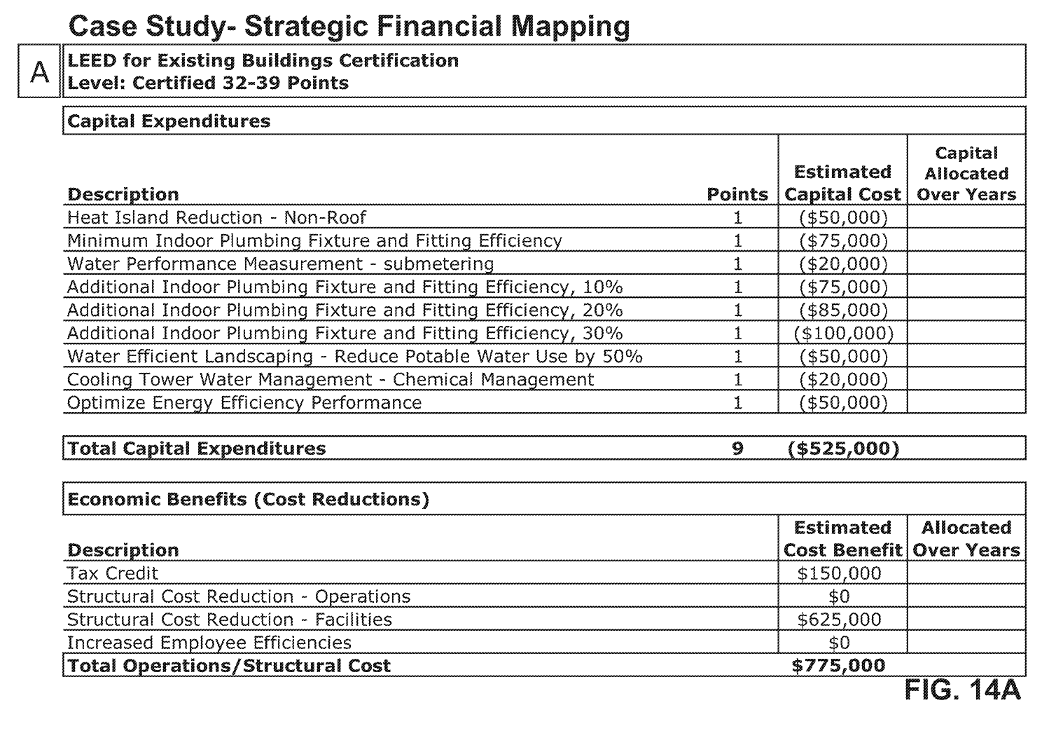

Referring to FIGS. 12A-12D are diagrams illustrating examples of a strategic facility mapping in accordance with a preferred embodiment of the present invention. The third phase generally provides for strategic facility mapping. When the high level site and facility assessment is complete, the tool user works with the client to scope, cost and further prioritize site and facility initiatives that best align criteria and objectives set in Phase 1. The initial phase takes the recommendations from Phase 2 and further defines each initiative relating to the scope, capital cost and potential opportunities. FIGS. 13A-13B show diagrams illustrating examples of strategic goals facility mappings in accordance with a preferred embodiment of the present invention. The strategic goals facility mappings generally provide a visual comparison of strategic goals relative to business strategy and facility assessment.

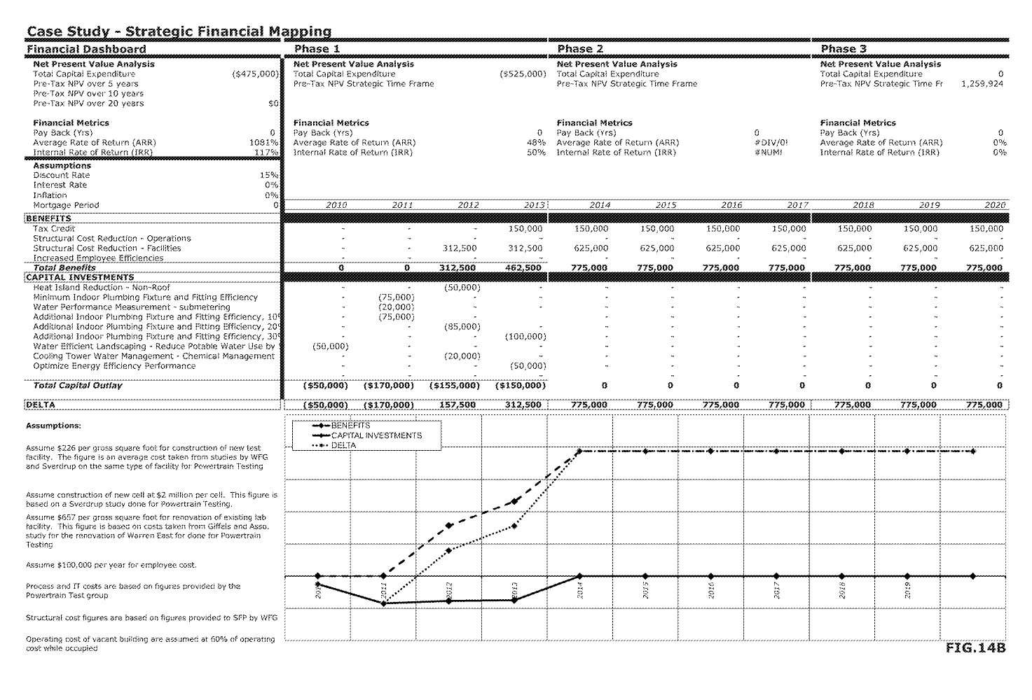

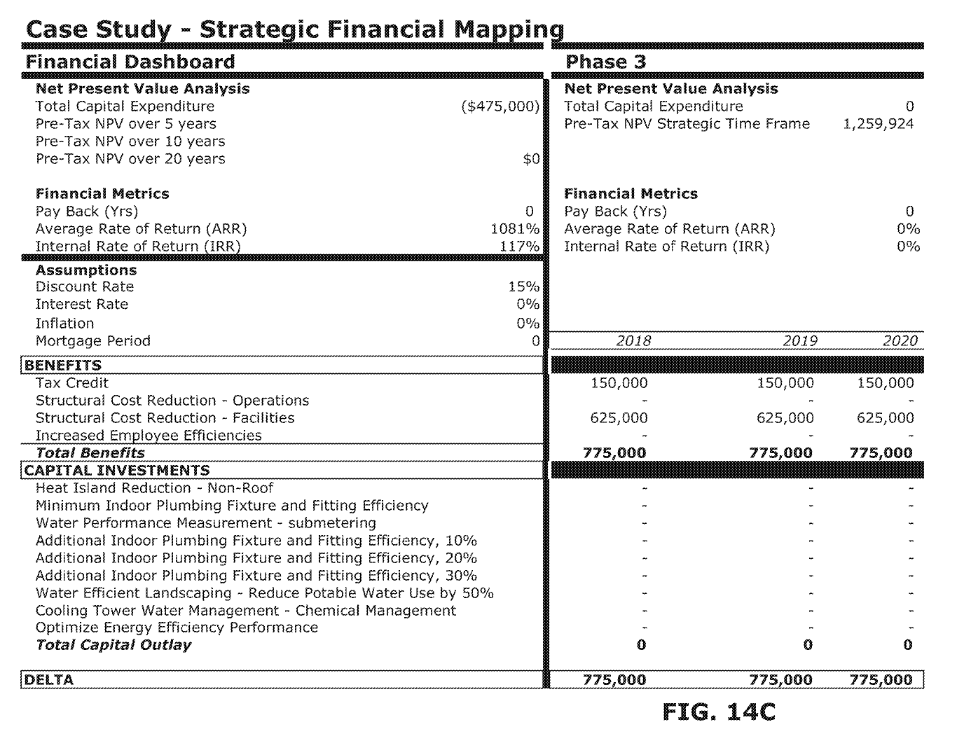

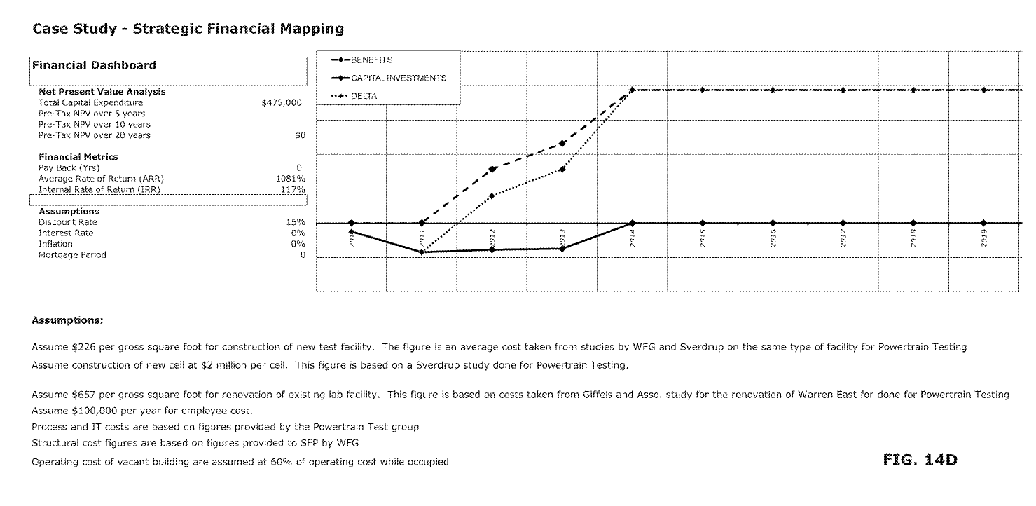

Referring to FIGS. 14A-14E are diagrams illustrating examples of strategic financial mapping in accordance with a preferred embodiment of the present invention. In Phase 3, the cost estimating along with a time frame for work completion is entered, for example, into a spreadsheet (e.g., implemented with Microsoft Excel; Microsoft and Excel are trademarks of Microsoft Corporation) called the Strategic Financial Mapping module. From the Strategic Financial Mapping module the Financial Analysis report is produced. The Financial Analysis report aligns and analyzes the sustainable criteria and establishes a road map for short and long term facility development. In the Strategic Financial Mapping module the key improvement projects that have been identified as Capital Priorities or Business Case Analyses may be transferred to a project input sheet. The project input sheet prompts the SFPlanner to enter the cost of the project, the expected return, and the timing of the investment. The Financial Analysis report may be implemented, in one example, as a cash flow model that shows the outlay of capital and the expected economic benefit over the expected time. The Financial Analysis report allows the SFPlanner to evaluate the return on investment, payback periods and net present value. The Financial Analysis report is an interactive report that allows the SFPlanner to change variables to allow for different outcomes.

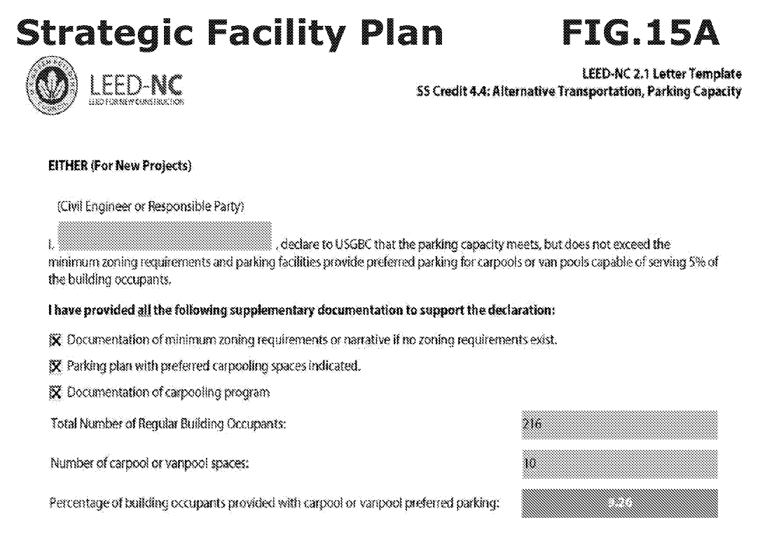

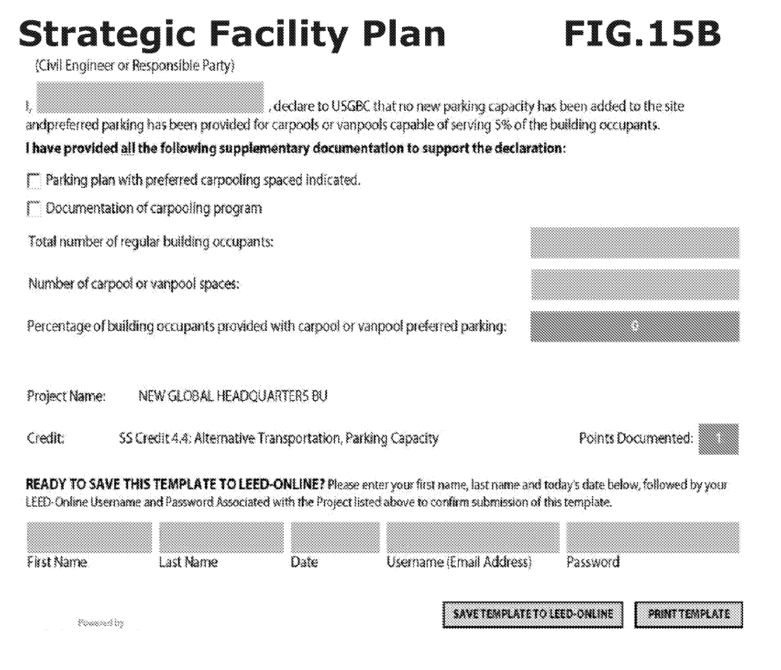

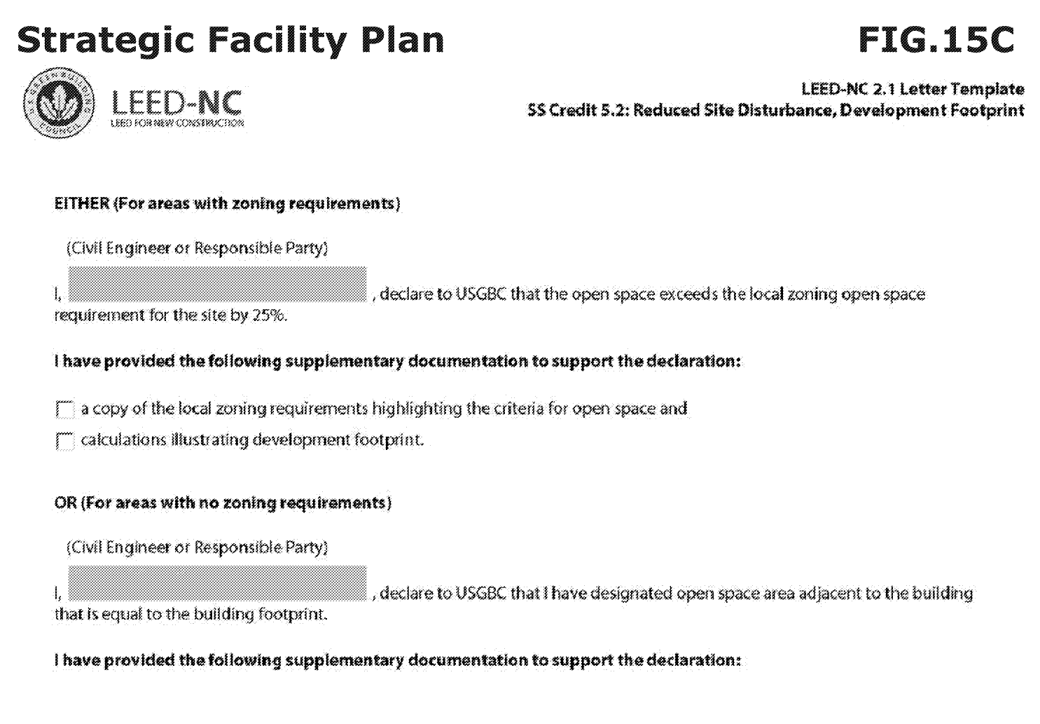

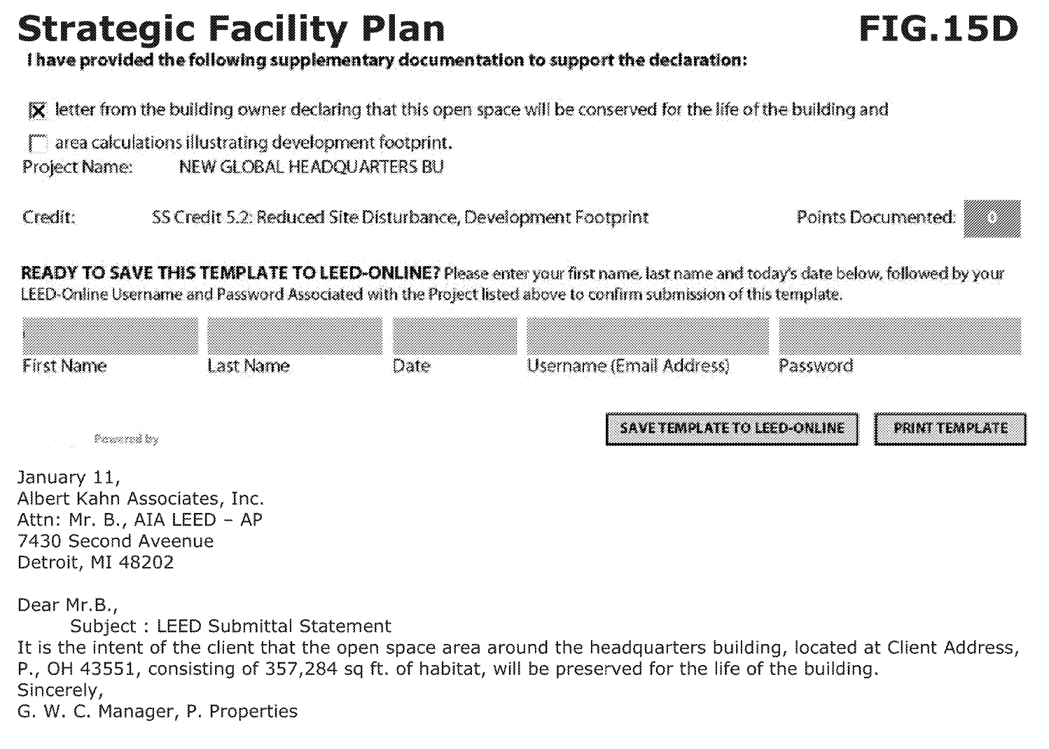

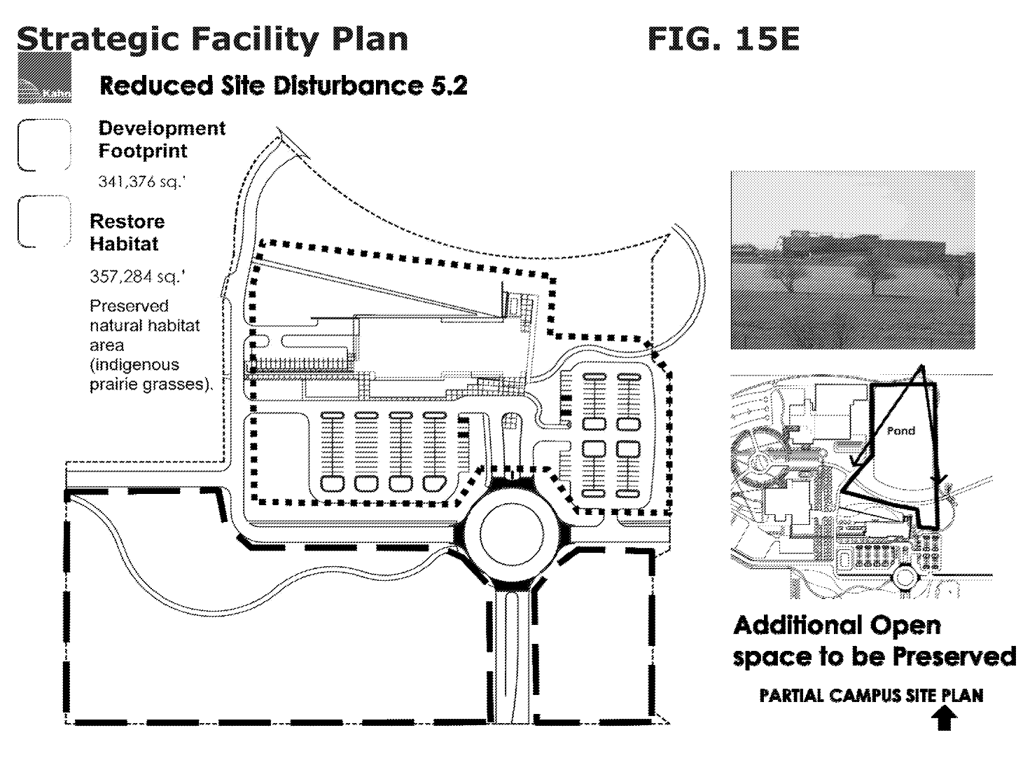

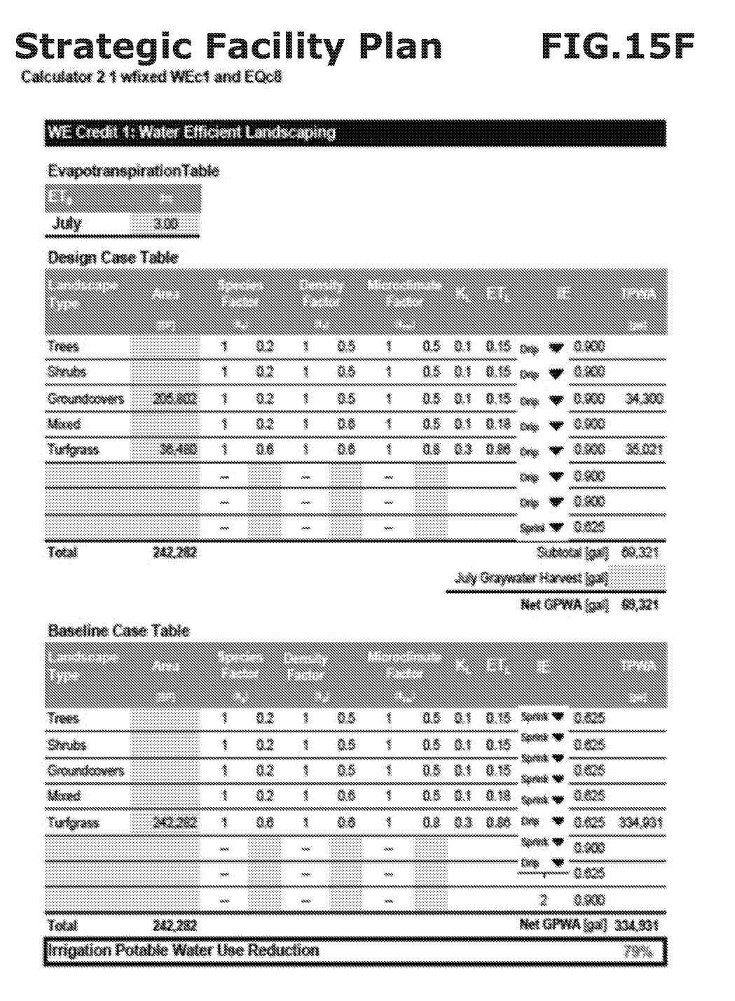

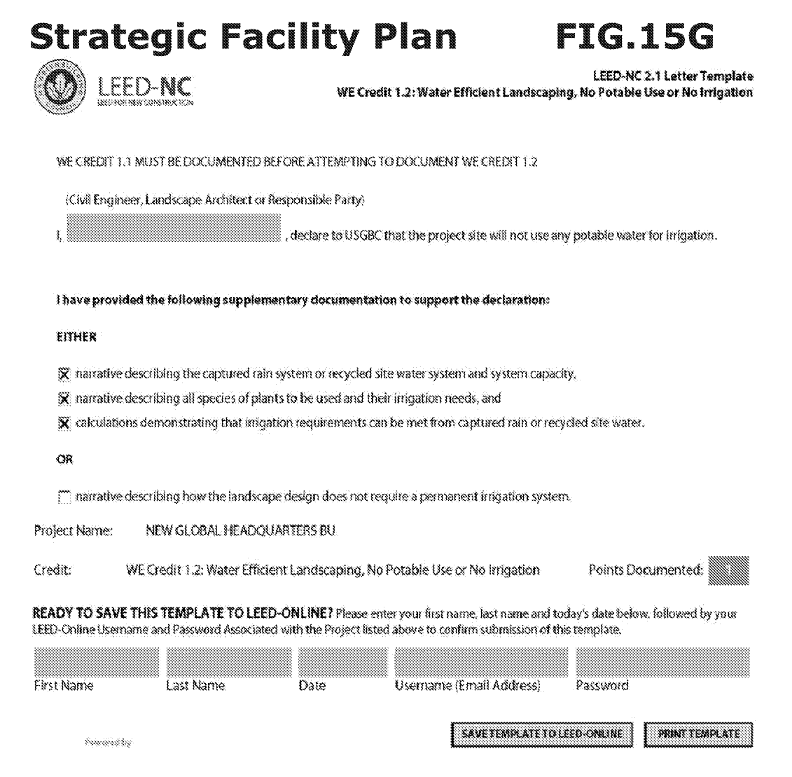

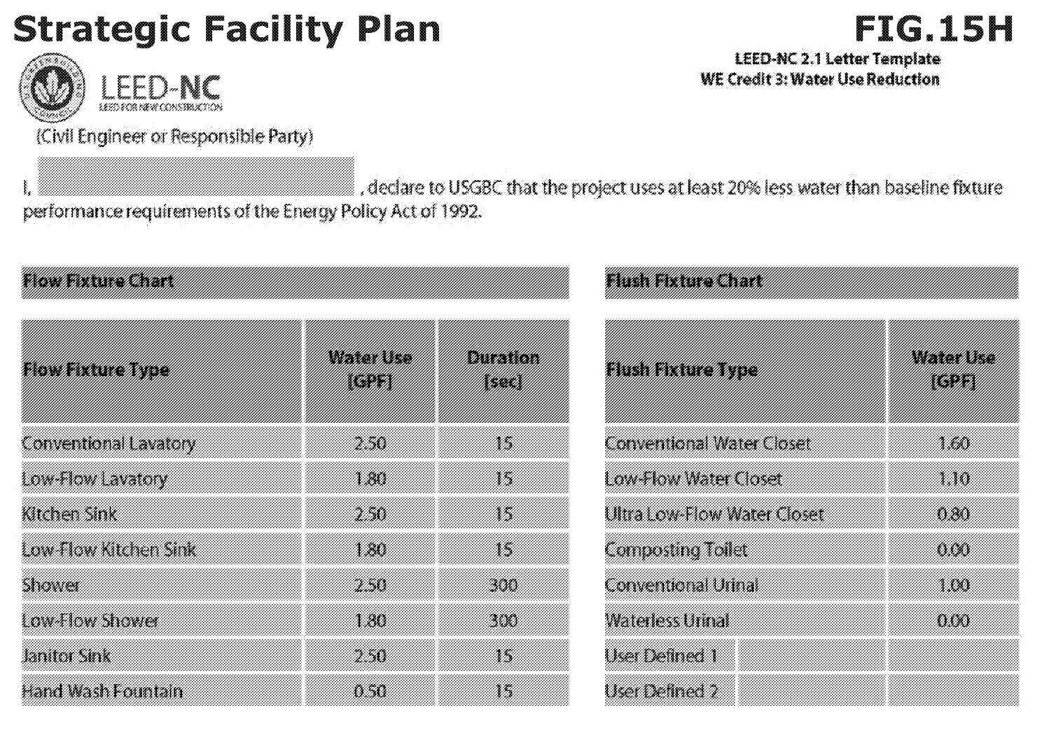

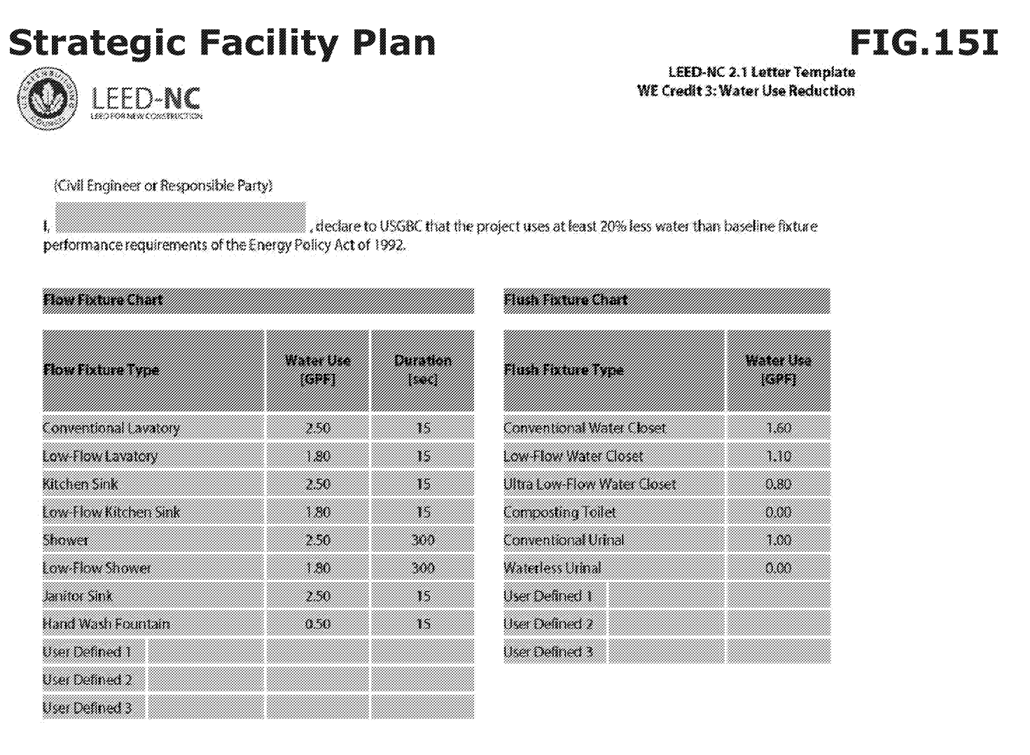

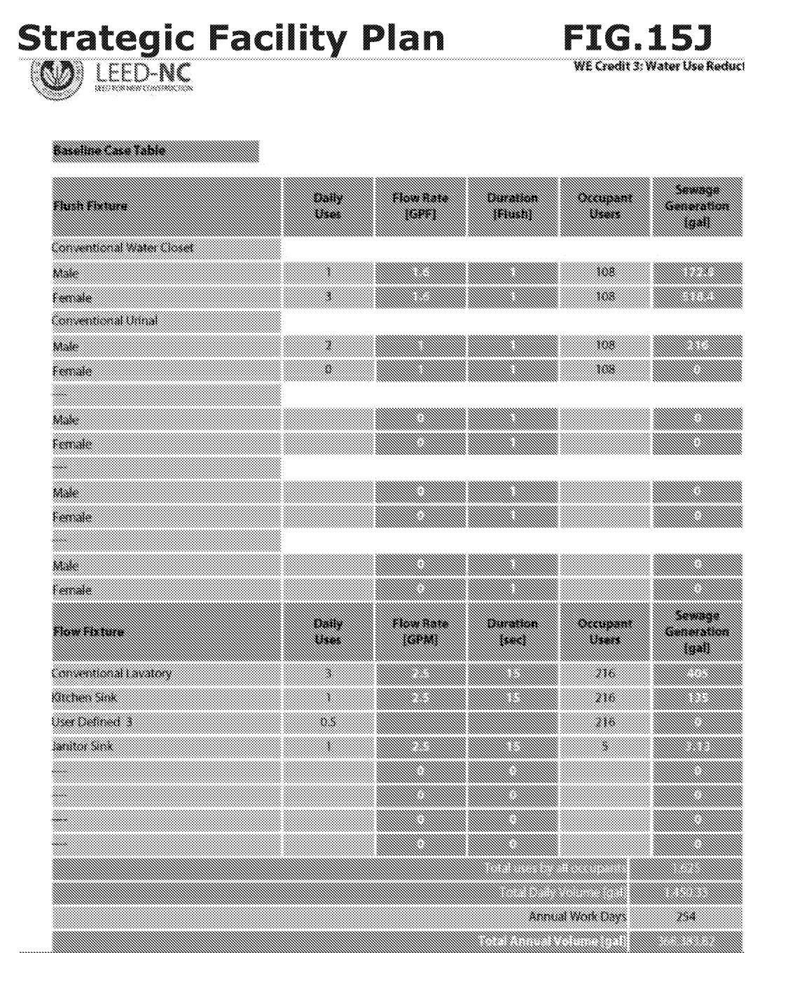

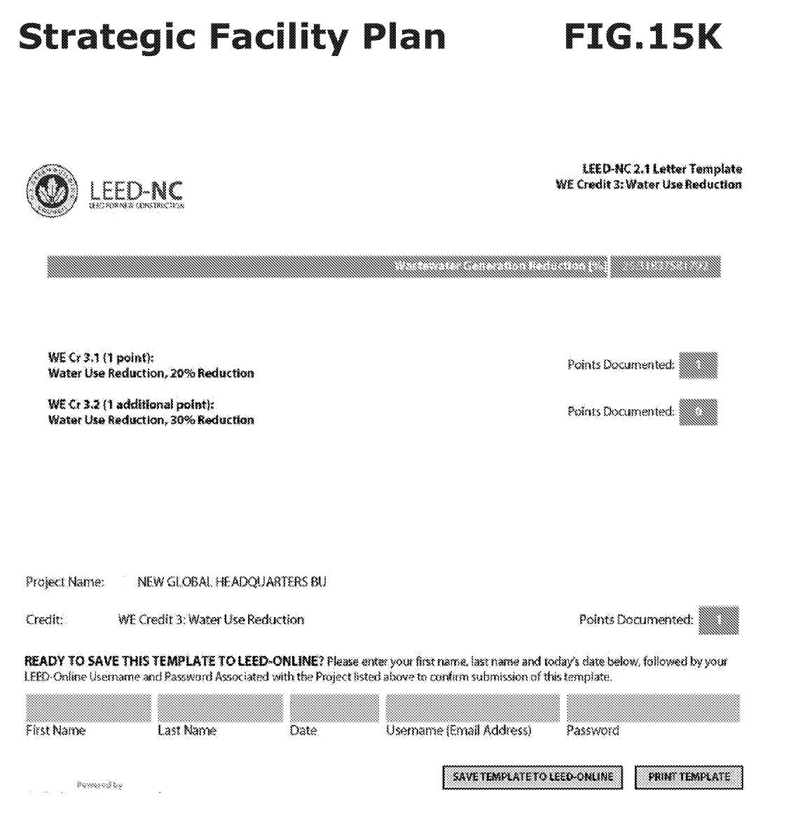

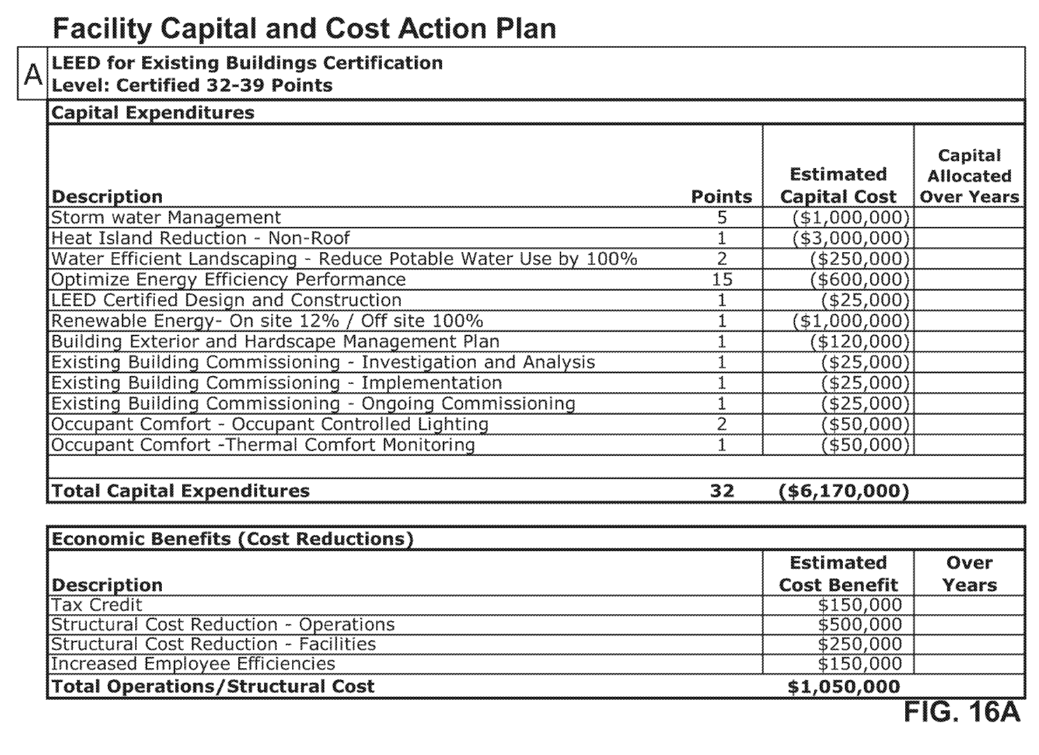

Referring to FIGS. 15A-15I are diagrams illustrating various parts of a Strategic Facility Plan generated using the Sustainable Capital Planning Tool in accordance with a preferred embodiment of the present invention. In the fourth phase, the Sustainable Capital Planning Tool generally provides a Strategic Facility Plan. The information developed in Phases 1 through 3 may be synthesized and the Strategic Facility Plan developed. The Strategic Facility Plan may be used by the client as a road map for short and long term facility development. The Strategic Facility Plan provides the client with a current profile and assessment of the client's current real estate holdings, key business strategies and the impact on current and future facility requirements and a phase short and long term facility plan that prioritizes projects and capital. The Strategic Facility Plan may provide input into the capital planning and budget forecasting process, along with providing an actionable plan for ISO 14000 compliance and LEED certifications.

Referring to FIGS. 16A-16B are diagrams illustrating various parts of a Facility Capital and Cost Plan generated using the Sustainable Capital Planning Tool in accordance with a preferred embodiment of the present invention. In the fourth phase, the deliverables generated by the Sustainable Capital Planning Tool may also include a Facility Capital and Cost Plan.

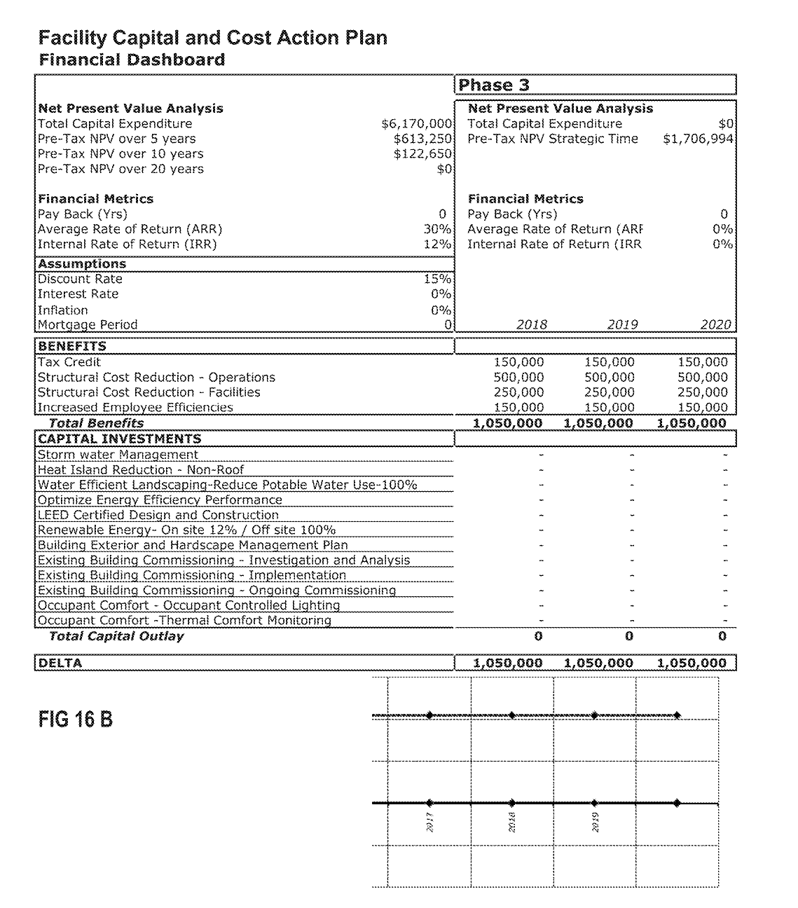

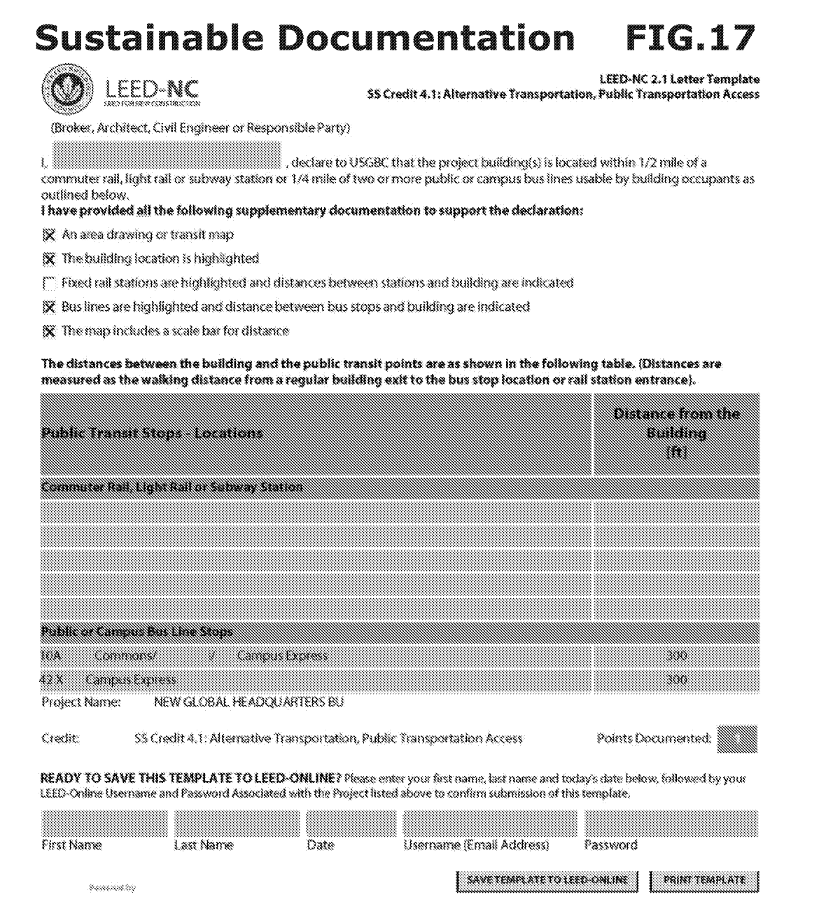

Referring to FIG. 17 is a diagram illustrating an example of sustainable documentation generated in accordance with a preferred embodiment of the present invention. In Phase 4, the Sustainable Administrator prepares the documentation for the sustainable certification submittal. The data and calculations are fine tuned. A final review of the certification level is held and the sustainable documentation is submitted to the appropriate certification organization. The Sustainable Administrator oversees the submittal process, including addressing any clarification requests and/or any necessary appeals.

Referring to FIG. 18, a diagram is shown illustrating a system 600 that may be used to implement methods in accordance with the present invention. The system 600 may comprise, in one example, a general purpose computer programmed in accordance with the teachings of the present disclosure. In one example, the system 600 may include a workstation (or terminal) 602 and a server (or central computer). However, other configurations may be implemented to meet the design criteria of a particular implementation. In one example, a Sustainability Capital Planning Tool in accordance with the present invention may be implemented as a software tool (or package) 606. The software may be stored on the workstation 602 or on the server 604. The software program 606 may comprise a number of modules 610-616, The modules may be implemented, for example, as independent program, sub-programs, sub-routines, etc. In one example, the module 610 may implement a Business and Environmental Strategy Analysis process in accordance with the present invention. In one example, the module 612 may implement a High Level Site and Facility Assessment process in accordance with the present invention. In one example, the module 614 may implement a Strategic Facility Mapping process in accordance with the present invention. In one example, the module 616 may implement a Strategic Facility Planning process in accordance with the present invention.

The functions performed by the diagrams of FIGS. 1-18 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products) or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

As used herein, the term “simultaneously” is meant to describe events that share some common time period but the term is not meant to be limited to events that begin at the same point in time, end at the same point in time, or have the same duration.

While the invention has been particularly shown and described with reference to the preferred embodiments thereof, it will be understood by those skilled in the art that various changes in form and details may be made without departing from the spirit and scope of the invention.

1. A method of sustainability capital planning comprising:
a first phase comprising performing a business and environmental strategy analysis;
a second phase comprising performing a high level site and facility assessment;
a third phase comprising performing a strategic facility mapping process; and
a fourth phase comprising performing a strategic facility planning process.

2. The method according to claim 1, wherein said first phase comprises performing at least one of identifying key business and environmental strategy milestones, analyzing current and future business demand, translating business demand into facility demand and providing a basis for facility utilization, identifying key sustainability criteria that provide the greatest return on investment and alignment with client strategy, assessing current impact statement, developing a balance scorecard and business strategy mapping.

3. The method according to claim 1, wherein said second phase comprises performing at least one of collecting data representative of current real world conditions, generating site assessments, generating facility assessments, generating facility operation assessments, generating environment compliance assessment and categorizing site and facility issues into SWOT categories.

4. The method according to claim 1, wherein said third phase comprises performing at least one of developing site and facility initiatives, evaluating and prioritizing site and facility initiatives and clustering key business strategies with site and facility initiatives.

5. The method according to claim 1, wherein said fourth phase comprises performing at least one of generating a facility vision, mission and key strategies, generating a current real estate profile and condition assessment, generating compliance plans, generating a project implementation plan and generating a projected facility capital and cost plan.

6. The method according to claim 1, wherein said first phase generates one or more deliverables selected from the group consisting of key business and environmental strategy milestones, current and future facility demand, key sustainability criteria, impact statement assessment, balance score card and business strategy map.

7. The method according to claim 1, wherein said second phase generates one or more deliverables selected from the group consisting of site assessment, facility assessment, environmental compliance assessment, and SWOT analysis of site and facility issues.

8. The method according to claim 1, wherein said third phase generates one or more deliverables selected from the group consisting of site and facility scope, capital cost and timing, balance scorecard evaluation and strategic facility map.

9. The method according to claim 1, wherein said fourth phase generates one or more deliverables selected from the group consisting of facility vision, mission and key strategies, current real estate profile and condition, compliance plans, project implementation plan and projected facility capital and cost plan.

10. A sustainable capital planning tool comprising:
a computer system; and
a computer readable storage medium connected to said computer system and storing one or more software programs, said one or more software programs comprising processor executable instructions configured to cause the computer system to perform computational steps associated with a business and environmental strategy analysis, a high level site and facility assessment, a strategic facility mapping process, and a strategic facility planning process.

11. The sustainable capital planning tool according to claim 10, wherein at least one of said one or more software programs comprise a Business and Facility Alignment module that includes a spreadsheet configured to align and prioritize a Strategic Business Analysis component, a Sustainable Credits component, and a Facility Condition Assessment component.

12. The sustainable capital planning tool according to claim 11, wherein the Business and Facility Alignment module comprises a form designed to align the input of sustainable facility improvement projects and business goals identified in a Business Strategy Analysis module.

13. The sustainable capital planning tool according to claim 10, wherein at least one of said one or more software programs comprise a Strategic Financial Mapping module implemented as an spreadsheet, wherein the spreadsheet is configured to receive cost estimating along with a time frame for work completion.

14. A computer readable medium containing processor executable instructions configured to cause a computer to perform computational steps of:
(A) a business and environmental strategy analysis;
(B) a high level site and facility assessment;
(C) a strategic facility mapping process; and
(D) a strategic facility planning process.

15. The computer readable medium according to claim 14, wherein said business and environmental strategy analysis comprises performing at least one of identifying key business and environmental strategy milestones, analyzing current and future business demand, translating business demand into facility demand and providing a basis for facility utilization, identifying key sustainability criteria that provide the greatest return on investment and alignment with client strategy, assessing current impact statement, developing a balance scorecard and business strategy mapping.

16. The computer readable medium according to claim 14, wherein said high level site and facility assessment comprises performing at least one of collecting data representative of current real world conditions, generating site assessments, generating facility assessments, generating facility operation assessments, generating environment compliance assessment and categorizing site and facility issues into SWOT categories.

17. The computer readable medium according to claim 14, wherein said strategic facility mapping process comprises performing at least one of developing site and facility initiatives, evaluating and prioritizing site and facility initiatives and clustering key business strategies with site and facility initiatives.

18. The computer readable medium according to claim 14, wherein said strategic facility planning process comprises performing at least one of generating a facility vision, mission and key strategies, generating a current real estate profile and condition assessment, generating compliance plans, generating a project implementation plan and generating a projected facility capital and cost plan.
